(19) United States
(12) Patent Application Publication
(10) Pub. No.: US 2026/0116713 A1
(43) Pub. Date: Apr. 30, 2026

(54) Drawworks Hydraulic Brake Performance Assessment System

(71) Applicant: Nabors Drilling Technologies USA, Inc., Houston, TX (US)

(72) Inventors: Najma Abdollahzadeh, Sugarland, TX (US); Christopher M. Magnuson, Houston, TX (US)

(21) Appl. No.: 19/372,017

(22) Filed: Oct. 28, 2025

Related U.S. Application Data
(60) Provisional application No. 63/712,927, filed on Oct. 28, 2024.

(51) Int. Cl. B66D 5/28; B66D 1/48; B66D 5/30; E21B 19/00

(52) U.S. Cl. CPC B66D 5/28; B66D 1/485; B66D 5/30; E21B 19/008

(57) ABSTRACT

A drawworks brake performance assessment system comprising a drawworks comprising a rotatable spool; a braking system comprising a rotor associated with the rotatable spool and at least one hydraulic disc brake comprising a master cylinder assembly and a caliper assembly comprising a caliper and opposing brake pads, wherein the master cylinder assembly is operable with the caliper assembly to manipulate one of the opposing brake pads to apply a clamping force to the rotor; and a brake sensor system comprising a sensor and an operations module, the sensor being operable to measure a displacement distance between one of the opposing brake pads and a surface of the rotor, and to output corresponding sensor data to the operations module that is operable to receive and process the sensor data and to determine one or more performance characteristics of the braking system based on the sensor data.

### RELATED APPLICATIONS

This application claims the benefit of U.S. Provisional Application Ser. No. 63/712,927, filed Oct. 28, 2024, and entitled, “Drawworks Hydraulic Brake Performance Assessment System,” which is incorporated by reference in its entirety herein.

### BACKGROUND

Whether for on-shore drilling or off-shore drilling, permanent (i.e., fixed), large-scale land and marine-based drilling rigs comprise an integrated collection of complex components and controls capable of facilitating drilling deep into the subsurfaces of the earth. Some structures, such as off-shore platforms, do not comprise a drilling rig, per se, but are nonetheless called “rigs.” As such, the term “rig” generally refers to the complex of equipment making up the permanent, large-scale structures, systems and controls used to penetrate and drill into the subsurfaces of the earth.

Drilling rigs come in a variety of sizes and configurations, with these comprising many common elements. Common to most large-scale, permanent drilling rigs is a hoisting system designed and configured to provide hoisting operations (i.e., raise, lower, suspend) with respect to the drill string, lift casing, drill string tubulars, and other components. The type and configuration of the components associated with a hoisting system is to some extent dependent upon the type of hoisting system. Generally speaking, a hoisting system can comprise various components depending upon its design and configuration. For example, a hoisting system can comprise, among other components/systems, a collection of components selected from a mast or derrick, a crown block, a traveling block, a hook, a swivel, a Kelly drive, a top-drive, a drawworks, and a drilling line. The crown block can be supported atop the mast or derrick in a stationary manner, with the traveling block supported by the drilling line in a moveable manner. The crown block and the traveling block together form a block and tackle system with the drilling line reeved through several components (e.g., around several pulleys or sheaves) between the traveling block and the crown block to facilitate the lowering and lifting of the drill string into and out of a borehole, as well as during drilling, tripping and handling operations. The drilling line is reeved through the several components of the crown block and the traveling block so as to provide the mechanical advantage needed for hoisting the substantial weights typically associated with the drill string and that are experienced during a drilling operation (e.g., up to several hundreds of thousands of pounds, and in some cases over a million pounds). The drilling line can be anchored at one end by a drawworks positioned at a first location relative to the mast or derrick, and at the opposite end by a dead line anchor positioned at a second location relative to the mast or derrick.

With respect to the drawworks and its function, the drawworks is essentially a controllable, large-scale, powered winch that spools or reels the drilling line in and out, thus providing the primary means for raising and lowering the traveling block (and thus the drill string and other drilling components suspended from the traveling block) relative to the floor or platform of the drilling rig. In a typical setup on a drilling rig, the drilling line is spooled onto a drum of a rotatable spool of the drawworks at a first end, and then routed to the crown block and the traveling block where it is caused to make between six and twelve passes between the sheaves or pulleys of the crown block and the traveling block to achieve the aforementioned mechanical advantage. The section of the drilling line extending from the drawworks to the first sheave or pulley of the crown block is known as the “fast line.” The section of the drilling line extending away from the last sheave or pulley of the traveling block and comprising the second end of the drilling line is known as the “dead line,” which can be routed to and secured to the dead line anchor, or to a structure of the mast or derrick. A typical drawworks setup or system comprises a rotatable spool or spool, a power source (e.g., electric motors, I/C engines), a transmission or gearing system, and a braking system.

A smooth-running, well-maintained drawworks can contribute considerably to the safe operation of a drilling rig. Conversely, a neglected or poorly maintained drawworks can be a significant safety hazard. In particular, the braking system(s) of a drawworks require(s) frequent checks and maintenance by rig operators and personnel to maintain the braking system(s) in good working condition. Indeed, static brake tests (SBT) are employed to ensure that the drawworks braking system(s) meet rated capacity and performance. During a static brake test of braking systems comprising hydraulic disc brakes, for example, drilling operations are temporarily ceased so that rig operators can check and test the holding capacity (i.e., the clamping force) of each caliper assembly associated with each of the hydraulic disc brakes. With the results of a successful test, drilling operations can resume. However, in the event that the testing reveals that the holding capacity or clamping force of one or more hydraulic brakes within the braking system fails to meet certain standards, rig operators are to systematically manually check and test different aspects (e.g., condition of components, performance, etc.) of each of the hydraulic disc brakes. For example, rig operators can manually check and test the thickness of the brake pads of the one or more caliper assemblies, and adjust the gap distance between the brake pads and one or more the discs accordingly to ensure these are within acceptable limits. Rig operators can also manually check to ensure that the disc surfaces and the brake pads are clean and that they are in acceptable condition. Other tests can also be conducted based on the type of drawworks in use. Due to the critical function the braking system(s) of a drawworks perform, and due to the need to ensure the safety of rig personnel, such static brake tests are recommended to be conducted at regular intervals. Currently, various aspects of a static brake test, such as testing the thickness of the brake pads and/or gap distance between the brake pads of a caliper assembly and the disc upon which they are operating, are performed manually by rig operators. Although regular brake checks are essential to ensure good operating conditions of the drilling rig and the safety of rig personnel, operational constraints can prevent rig operators from stopping drilling operations at ideal or scheduled times so that such checks, including checking the gap distances of the caliper assemblies, can be performed. This can lead to uneven or worn brake pads, unclean or contaminated brake pad and/or disc surfaces, maladjusted calipers and associated air gap distances, and other problems that can negatively impact drilling operations and jeopardize the safety of rig personnel.

### SUMMARY

An initial overview of the present technology is provided below and then specific examples are described in further detail later. This initial summary is intended to aid readers in understanding the examples of the present technology more quickly, but is not intended to identify key features or essential features of the examples, nor is it intended to limit the scope of the present technology or the claimed subject matter.

In one example, the present technology sets forth a drawworks brake performance assessment system operable within a drill rig for determining, in real-time, braking performance of a braking system of a drawworks during a drilling operation, the system comprising a drawworks comprising a rotatable spool having a drum operable to receive a drilling line; and a braking system comprising at least one rotor and at least one hydraulic disc brake, the at least one rotor being associated with the rotatable spool such that the at least one rotor rotates with the rotation of the rotatable spool. The at least one hydraulic disc brake can comprise a master cylinder assembly; a caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor; and a brake sensor system comprising a sensor and an operations module, the sensor being operable with the hydraulic disc brake of the braking system of the drawworks to measure a displacement distance between at least one of the opposing brake pads and a surface of the rotor, and to output corresponding sensor data to the operations module, wherein the operations module comprises a computing device operable to receive and process the sensor data and to determine one or more performance characteristics of the braking system based on the sensor data.

The present technology also sets forth a drawworks operable within a drilling rig, the drawworks comprising a rotatable spool having a drum; and a braking system. The braking system can comprise a rotor associated with the rotatable spool such that the at least one rotor rotates with the rotation of the rotatable spool; a first hydraulic disc brake comprising a master cylinder assembly, and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor; a second hydraulic disc brake comprising a master cylinder assembly, and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor; and a brake sensor system operable with the braking system, and comprising first and second sensors and an operations module. The first sensor can be operable with the first hydraulic disc brake of the braking system to measure a displacement distance of one of the opposing brake pads and the rotor, and to output corresponding sensor data, and the second sensor can be operable with the second hydraulic disc brake of the braking system to measure a displacement distance of one of the opposing brake pads and the rotor, and to output corresponding sensor data. The operations module can comprise a computing device operable to receive the sensor data from the first and second sensors and to determine one or more performance characteristics of the braking system based on the sensor data.

The present technology further sets forth a brake sensor system operable with a drawworks of a drilling rig, the brake sensor system comprising a plurality of sensors, each operable with a respective hydraulic disc brake of a braking system of a drawworks of a drilling rig. Each respective hydraulic disc brake can comprise a master cylinder assembly, and a caliper assembly. The caliper assembly can comprise a caliper and opposing brake pads supported by the caliper that are operable to engage a rotor, wherein the master cylinder assembly is operable with the caliper assembly to manipulate at least one of the opposing brake pads to apply a clamping force to the rotor. The caliper assembly can further comprise a plurality of braking system interfaces, each comprising a mounting assembly operable to support a sensor of the plurality of sensors on a respective hydraulic disc brake in a position suitable for measuring a displacement distance between at least one of the opposing brake pads and the rotor, and to output corresponding sensor data; and an operations module comprising at least one processor, and one or more memory devices. The memory devices can include instructions that, when executed by the at least one processor, cause the system to selectively operate the plurality of sensors, each sensor configured to measure a displacement distance between the rotor and at least one of the opposing brake pads of a hydraulic disc brake of the plurality of hydraulic disc brakes; receive the sensor data from one or more sensors of the plurality of sensors; determine one or more performance characteristics of the braking system of the drawworks based on the sensor data; and communicate the one or more performance characteristics to an operator.

The present technology still further sets forth a method for facilitating the determination, in real-time, of one or more performance characteristics of a braking system of a drawworks of a drilling rig during a drilling operation, the method comprising configuring a drawworks with a rotatable spool having a drum; configuring the drawworks with a braking system operable with the rotatable spool, the braking system comprising at least one rotor operable with at least one hydraulic disc brake comprising a master cylinder assembly and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor; configuring the drawworks to comprise a brake sensor system operable to measure a displacement distance between at least one of the opposing brake pads and the one or more rotors, and to output corresponding sensor data to an operations module; and facilitating the determination of one or more performance characteristics of the braking system based on the sensor data.

### BRIEF DESCRIPTION OF THE DRAWINGS

Features and advantages of the present technology will be apparent from the detailed description which follows, taken in conjunction with the accompanying drawings, which together illustrate, by way of example, features of the technology; and, wherein:

FIG. 1 illustrates basic schematic of an exemplary drilling rig in accordance with an example of the present disclosure.

FIG. 2 illustrates a block diagram of a drawworks brake performance assessment system in accordance with an example of the present disclosure.

FIG. 3 illustrates a perspective view of certain components of an exemplary drawworks and an exemplary brake sensor system of the drawworks brake performance assessment system of FIG. 2, thus illustrating an example implementation of the drawworks brake performance assessment system of FIG. 2 in accordance with an example of the present disclosure.

FIG. 4 illustrates a more detailed partial perspective view of the exemplary drawworks and the exemplary brake sensor system of FIG. 3, and the example implementation of the drawworks brake performance assessment system of FIG. 2.

FIG. 5 illustrates a more detailed partial perspective view of the exemplary drawworks and the exemplary brake sensor system of FIG. 3, and the example implementation of the drawworks brake performance assessment system of FIG. 2, with the partial perspective view illustrating the detail A as delineated in FIG. 3.

FIG. 6 illustrates a partial side view of the exemplary drawworks and the exemplary brake sensor system of FIG. 3 and the example implementation of the drawworks brake performance assessment system of FIG. 2.

FIG. 7 illustrates a perspective view of a hydraulic disc brake having a mounted sensor as part of the exemplary drawworks and the exemplary brake sensor system of FIG. 3.

FIG. 8 illustrates a flow chart of a method and drawworks brake performance assessment system for facilitating the determination, in real-time, of one or more performance characteristics of a braking system of a drawworks.

FIG. 9 illustrates a block diagram of an example of a computing device that may be used with or as part of the brake sensor system, as well as to execute a method for operating a brake sensor system associated with a braking system of a drawworks, in accordance with an exemplary of the present disclosure.

Reference will now be made to the examples illustrated, and specific language will be used herein to describe the same. It will nevertheless be understood that no limitation of scope is thereby intended.

### DETAILED DESCRIPTION

The following detailed description of exemplary embodiments of the present technology refers to the accompanying drawings, which form a part hereof and in which are shown, by way of illustration, examples in which the present technology may be practiced. While these exemplary embodiments are described in sufficient detail to enable those skilled in the art to practice the present technology, it should be understood that other embodiments may be realized and that various changes to the present technology may be made without departing from the spirit and scope of the present technology. Thus, the following more detailed description of the embodiments of the present technology is not intended to limit the scope of the technology, as claimed, but is presented for purposes of illustration only to describe the features and characteristics of the present technology, and to sufficiently enable one skilled in the art to practice the technology.

### DESCRIPTION OF TERMS

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

The term “operations module” refers to a computer or computing device that is a component or element of the brake sensor system. The operations module can comprise one or more processors and one or more memory devices, as well as one or more software components stored on the memory device(s), wherein the software component(s) comprise(s) executable code or instructions facilitating the functions or processes of the brake sensor system as described herein. Specifically, the executable code or instructions can be executed by the one or more processors to cause the brake sensor system to carry out its intended functions and processes. In one example, the operations module can comprise a dedicated computing device. In another example, the operations module of the brake sensor system can comprise or be part of a high-level control module or system, such as a drawworks control system or a drilling rig control system, wherein the operations module comprises the one or more processors and the one or more memory devices, as well as one or more software components stored on the memory device(s), of the high-level control module, wherein the software component(s) comprise(s) executable code or instructions facilitating the functions or processes of the brake sensor system as described herein.

The term “performance characteristic” refers to various types of characteristics of the braking system of the drawworks that can comprise a representative value or expression that a user can use to estimate, indicate or otherwise assess how one or more aspects of the braking system are functioning (e.g., a status) or how they may perform during a future braking event (e.g., an estimation of the magnitude of a clamping force to be applied by a hydraulic disc brake, and particularly the brake pads, to a rotor during a future braking event). A representative expression can comprise a measurement, a determination based on a comparison of two or more performance characteristics, an observation, or other type that is based on sensor data output by one or more sensors of the brake sensor system as associated with one or more hydraulic disc brakes, respectively. In one example, a representative expression can comprise a measurement value having a unit of measurement, wherein the measurement value is representative of a directly measured aspect of the braking system (e.g., a spacing or gap distance “D” between one or more brake pads and a rotor expressed as a unit of length, a displacement of a moveable component of a linear sensor expressed as a unit of length, and others). In another example, a representative expression can comprise one that is calculated or determined (e.g., derived) by a computer or computing device of the operations module, using one or more mathematical formulae or conversion functions, and that is based on sensor data from one or more sensors of the brake sensor system. In one aspect, a calculated or determined representative expression of a performance characteristic can be based on the sensor data from a single sensor operating on a single hydraulic disc brake (e.g., a determined compression force of a brake pad acting on the rotor). In another aspect, a calculated or determined representative expression of a performance characteristic can be based on the sensor data from two or more sensors associated with respective hydraulic disc brakes (e.g., the two sensors being operable with respective hydraulic disc brakes on the same rotor, or on different rotors, or both), wherein the performance characteristic in this case can be more aptly described as a comparison performance characteristic. Performance characteristics can be obtained, calculated, and, if desired, conveyed (e.g., via a GUI) in real-time during operation of the drawworks and during a drilling operation. These can also be compared to established standards, respectively, to ascertain if the braking system is in compliance with such standards. In another example, a representative expression can comprise an observance, an estimation, or other expression based on the a directly measured aspect of the braking system, a calculated expression, or a combination of these.

The term “comparison performance characteristic” refers to a type of performance characteristic that is based on a comparison of the sensor data from two or more sensors associated with two or more hydraulic disc brakes, respectively, and/or that is based on a first performance characteristic (e.g. having a first representative expression) calculated or determined from the sensor data of a first sensor associated with a first hydraulic disc brake being compared with that of a second performance characteristic (e.g., having a second representative expression) calculated or determined from the sensor data of a second sensor associated with a second hydraulic disc brake (e.g., a comparison of the clamping forces of two or more master cylinder assemblies and two or more corresponding caliper assemblies operating on or with the same rotor, a comparison of rates of wear of two brake pads associated with two different caliper assemblies or two different hydraulic disc brakes altogether, and others). Comparison performance characteristics can also be calculated and conveyed in real-time. The term “performance characteristic” is intended to encompass and include any comparison performance characteristic types.

### Examples of the Technology

As indicated above, a drawworks for use on a drilling rig can comprise a rotatable spool having a drum. The rotatable spool can also comprise one or more flanges supported about the drum. A rotatable spool can comprise a single flange, or multiple flanges, such as flanges positioned at opposing ends of the drum. The drawworks can further comprise a braking system comprising a primary braking system and a secondary or auxiliary braking system for slowing and/or arresting rotation of the rotatable spool. In one example, a drawworks can comprise a primary braking system in the form of a mechanical brake (e.g., a hydraulic disc brake), and a secondary or auxiliary braking system in the form of an electromechanical brake (e.g., a hydromatic braking system, an electro-dynamic or eddy current braking system, magnetic particle braking system, or others) used to control the descent rate of the traveling block and the components suspended therefrom (the drill string, the top-drive, etc.). With respect to a primary braking system of the drawworks comprising one or more hydraulic disc brakes, the one or more hydraulic brakes can comprise one or more rotors that can be associated with the rotatable spool, such that the one or more rotors rotate with the rotatable spool. The one or more rotors can comprise one or more flanges, respectively, of the rotating spool, or the one or more rotors can be separate structural components associated with the rotating spool. The one or more hydraulic brakes can each further comprise a master cylinder assembly comprising hydraulic fluid lines and a piston assembly, the piston assembly comprising an actuation piston, a biasing element (e.g., a spring or spring-like device or system) operable exert a return force on the actuation piston, and a hydraulic fluid reservoir. The one or more hydraulic disc brakes can each further comprise a caliper assembly comprising a caliper, a caliper piston supported by the caliper, and opposing brake pads supported by the caliper. The master cylinder assembly can be operable with the caliper assembly to manipulate at least one of the opposing brake pads to apply a clamping force to the rotor. More specifically, during operation or during a braking event where hydraulic forces are applied and at work by actuation of the master cylinder assembly of the hydraulic disc brake, the caliper piston of the caliper assembly can be actuated by the actuation piston of the master cylinder assembly via hydraulics to manipulate at least one of the opposing brake pads to apply a clamping force to the rotor to slow and/or arrest rotation of the rotor (and the rotating spool). The biasing member of the master cylinder assembly, discussed below, can provide or apply a return force to the actuation piston to return the actuation piston to an initial starting position upon the removal of the hydraulic forces, whereby the opposing brake pads are disengaged from the rotor.

In another example, a drawworks can comprise a primary braking system in the form of a regenerative braking system comprising a direct transmission system connecting the drawworks to the power source (e.g., electric motors), and a secondary or auxiliary (or emergency) braking system in the form of a hydraulic braking system that functions to engage when the power source is inactive or at rest, wherein the hydraulic braking system functions as both an emergency brake and a parking brake. In this example, the secondary or auxiliary braking system can be configured in a similar manner as described above, with the secondary braking system comprising one or more hydraulic disc brakes. The one or more hydraulic brakes can comprise one or more rotors that can be associated with the rotatable spool, such that the one or more rotors rotate with the rotatable spool. The one or more rotors can comprise one or more flanges, respectively, of the rotating spool, or the one or more rotors can be separate structural components associated with the rotating spool. The one or more hydraulic brakes can each further comprise a master cylinder assembly comprising hydraulic fluid lines and a piston assembly, the piston assembly comprising an actuation piston, a biasing member (e.g., a spring or a spring-like device or system, such as a spring-applied hydraulic release mechanism), and a hydraulic fluid reservoir. The one or more hydraulic disc brakes can each further comprise a caliper assembly comprising a caliper, a caliper piston supported by the caliper, and opposing brake pads supported by the caliper. The master cylinder assembly can be operable with the caliper assembly to manipulate at least one of the opposing brake pads to apply a clamping force to the rotor. More specifically, during operation where hydraulic forces are applied by actuation of the hydraulic disc brake, the caliper piston of the caliper assembly can be actuated by the actuation piston of the master cylinder assembly via hydraulics to manipulate at least one of the opposing brake pads to apply a clamping force to the rotor to slow and/or arrest rotation of the rotor (and the rotating spool). The biasing member of the master cylinder assembly can provide or apply a return force to the actuation piston to return the actuation piston to an initial starting position upon the removal of the hydraulic forces, whereby the opposing brake pads are disengaged from the rotor.

It is noted that one or more master cylinder assemblies and one or more caliper assemblies in the example drawworks can be operable with any given rotor (i.e., one or more master cylinder and one or more caliper assemblies can be supported by and operable on a single rotor, such that the rotor is common to these). For instance, the primary braking systems of a drawworks utilized in a large-scale drilling rig can comprise between two and three master cylinder assemblies and corresponding caliper assemblies operable with each of two rotors (for a total of four to six).

The present disclosure sets forth technology that facilitates operators knowing how much effective braking is present in the drawworks braking system, such as in an emergency brake of a drawworks employing one or more hydraulic disc brakes. Drawworks with emergency brakes must be capable of stopping approximately two times the rated load per American Petroleum Institute (API) specifications. The braking systems currently in the market state what they should be capable of providing should all specifications be met. However, these systems don't provide true compression forces being applied. Drawworks pull tests per tower watch have been developed to determine actual holding loads, but not true performance. Hence, providing a drawworks with a brake sensor system as taught herein will be able to facilitate operators knowing the braking force of the hydraulic disc brakes based on the measured distance between brake pads and a braking surface of a rotor, as well as a determined thickness of the brake pads. From this, a wealth of brake performance characteristics can be determined and known, including knowing how the brake system will perform in future braking events, thus providing significant advantages to operators over a drawworks without such a brake sensor system.

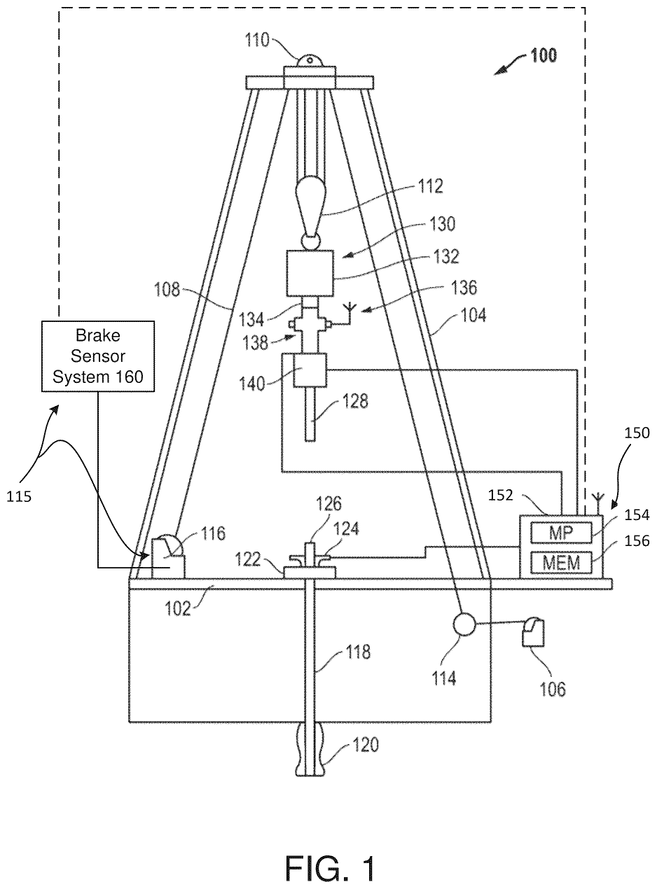

To further describe the present technology, examples are now set forth and described with reference to the figures. These examples are not intended to be limiting in any way. With reference to FIG. 1, illustrated is an exemplary schematic view of a drilling rig 100 in the process of drilling a wellbore in accordance with an example of the present technology. The drilling rig 100 can include a drill rig floor 102 and a mast or derrick 104 extending above the rig floor 102. A supply reel 106 can supply drilling line 108 to a crown block 110 and traveling block 112 configured to hoist various types of drilling equipment above the rig floor 102. The drilling line 108 can be secured to a deadline anchor 114. A drawworks 116 can regulate the amount of drilling line 108 in use and, consequently, the height of the traveling block 112 at a given moment. Below the rig floor 102, a drill string 118 can extend downward into a wellbore 120. The drill string 118 can be held stationary with respect to the rig floor 102, for example, by a rotary table 122 and slips 124 (e.g., power slips). A portion of the drill string 118 can extend above the rig floor 102, forming a stump 126 to which another length of tubular 128 (e.g., a joint of drill pipe or a section of casing) may be added.

In an example, a tubular drive system 130, hoisted by the travelling block 112, can position the tubular 128 above the wellbore 120. The tubular drive system 130 can include a top drive 132, a quill 134 (e.g., a sub, a gripping device), and a torque turn system 136 (e.g., a wireless torque turn system, a tubular monitoring system) configured to monitor, control, or evaluate forces acting on the tubular drive system 130, such as torque, weight, and so forth. The quill 134 can extend from the top drive 132 toward the rig floor 102. The torque turn system 136 can measure forces acting on the tubular drive system 130 via a span block 138 (e.g., a sub). In an example, the span block 138 can include a sensor, such as strain gauges, gyroscopes, pressure sensors, accelerometers, magnetic sensors, optical sensors, or other sensors, which may be communicatively linked or physically integrated with the torque turn system 136. Moreover, in certain examples, the span block 138 (e.g., via the torque turn system 136) can be coupled to the top drive 132 at a first end (e.g., via the quill 134) and to a casing drive system 140 (e.g., a tubular handling system) at a second end. In certain examples, the torque turn system 136 may not be utilized and the span block 138 may be directly coupled between the quill 134 and the casing drive system 140 or tubular 128. The tubular drive system 130, once coupled with the tubular 128, can lower the coupled tubular 128 toward the stump 126 and rotate the tubular 128 such that it connects with the stump 126 and becomes part of the drill string 118.

The drilling rig 100 can further include a drilling rig control system 150 configured to control various systems and components of the drilling rig 100 that grip, lift, release, and support the tubular 128 and the drill string 118 during a casing running or tripping operation. For example, the control system 150 can control operation of the casing drive system 140 and the slips 124 based on measured feedback (e.g., from the torque turn system, from the span block, from other sensors) to ensure that the tubular 128 and drill string 118 are adequately gripped and supported by the casing drive system 140, the torque turn system 136, the tubular drive system 130, or the slips 124 during a casing running operation. In this manner, the control system 150 can reduce or eliminate incidents where lengths of the tubular 128 or drill string 118 are unsupported. Moreover, the control system 150 can control auxiliary equipment such as mud pumps, robotic pipe handlers, and the like as will be appreciated by those skilled in the art.

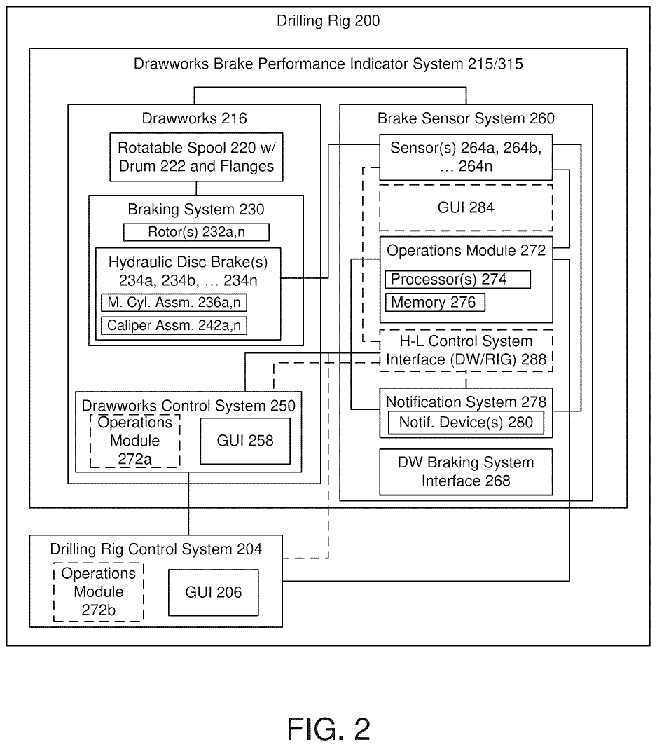

In the illustrated example, the control system 150 includes
a controller 152 having one or more microprocessors 154 and a memory 156, as well as a graphical user interface (not shown, but see FIG. 2). For example,
the controller 152 can be an automation controller which may include a programmable logic controller (PLC). The memory 156 can be a non-transitory (not merely a signal), tangible, computer-readable media, which may include executable instructions that may be executed by the microprocessor(s) 154. The controller 152 can receive feedback from the torque turn system 136 or other sensors that detect measured feedback associated with operation of the drilling rig 100. For example, the controller 152 can receive feedback from the tubular drive system 130 or other sensors in wired or wireless transmission. Based on the measured feedback, the controller 152 can regulate operation of the tubular drive system 130 (e.g., rotation speed, weight on bit).

During operation, the traveling block 112 can be configured to move up and down relative to the rig floor 102. For example, the traveling block 112 can move up to remove the tubular 128 from the drill string 118 or move down to add the tubular 128 to the drill string 118.

While the above described drilling rig 100 employing a top drive may be used with the technology described herein, skilled artisans will recognize after reading the entire disclosure that other drilling systems can be used with the technology described herein. For instance, in another example, the drilling rig can include a rack and pinion style drive mechanism, a kelly and rotary table, or other known drilling components operable with the drilling rig.

The drilling rig 100 can further comprise a drawworks brake performance assessment system 115 operable to automate aspects of drawworks brake checks, and to at least reduce, if not eliminate, the need for certain periodic, manual brake inspections that can disrupt drilling operations at inopportune times (although manual checks can still be performed if needed or desired). As part of this system, the drawworks 116 of the drilling rig 100 can further comprise a brake sensor system 160, which, in one example, can be a stand-alone system that can be retrofit to an existing drawworks in use on the drilling rig 100, wherein the brake sensor system 160 can comprise its own operations module (e.g., a computer and various software components related to and facilitating the function of the brake sensor system, and a graphical user interface), or wherein the brake sensor system 160 can be configured to interface and integrate with a high-level control system, such as the control system of the drawworks 116, and/or the control system 150 of the drilling rig 100, if available. In another example, the brake sensor system 160 can initially be part of (i.e., an integral component of) a manufactured drawworks to be installed on an existing drilling rig 100. In this example, the brake sensor system 160 can comprise a stand-alone system comprising dedicated components, or it can be configured with various components capable of interfacing and integrating with the control system of the drawworks 116, and/or the control system 150 of the drilling rig 100, if available. In still another example, the brake sensor system 160 can be an initial component of an initial drawworks 116 build of a constructed drilling rig 100. In this example, the brake sensor system 160 can comprise a stand-alone system, or it can be integrated with the control system of the drawworks 116, and/or the control system 150 of the drilling rig 100, if available. The drawworks brake performance assessment system 115 and the brake sensor system 160 are discussed in greater detail below.

With reference to FIG. 2, illustrated is a drawworks brake performance assessment system 215 in accordance with an example of the present disclosure, which drawworks brake performance assessment system 215 can be part of a drilling rig 200 comprising a drilling rig control system 204 having a graphical user interface (GUI) 206, and which control system 204 can be the same or similar to the control system 150 discussed above and shown in FIG. 1 in that it can comprise one or more microprocessors and one or more memory devices having executable instructions that can be executed by the one or more microprocessors.

The drawworks brake performance assessment system 215 can comprise a drawworks 216 operable to receive the drilling line of a hoisting system, and to spool or reel in and out the drilling line, as discussed above. The drawworks 216 can comprise a rotatable spool 220 having a drum 222 upon which the drilling line is spooled or wound, as well as one or more flanges that are operable with the drum to provide lateral support to the drilling line and to maintain the drilling line on the drum 222 as it is spooled in and out. The one or more flanges can be supported about respective ends of the drum 222. In one aspect, the one or more flanges can be integrally formed with the drum 222. In another aspect, the one or more flanges can be separate components from the drum 222, and can be coupled to the drum 222 using bolts or other fasteners.

The drawworks 216 can further comprise a braking system 230 operable with the rotatable spool 220 to provide a braking function within the drawworks 216, namely to slow and/or arrest rotation of the rotatable spool 220, and thus slow or arrest the spooling in or out of the drilling line, thus slowing or stopping movement of the traveling block of the hoisting system of the drilling rig 200. The braking system 230 can comprise one or more rotors and one or more hydraulic brakes configured to provide the braking function of the braking system 230.

In one example, the one or more flanges (typically two) directly adjacent the drum 222 can further be configured and function as a component of the braking system 230 of the drawworks 216. Specifically, the one or more flanges can comprise the one or more rotors 232a up to 232n operable with one or more hydraulic disc brakes (see hydraulic disc brakes 234a, 234b, . . . 234n, with hydraulic disc brake 234n representing any number of hydraulic disc brakes) of the braking system 230 operable within the drawworks 216. In other words, the one or more flanges of a rotating spool 220 can provide a dual-function in that they can function to help manage the spooling in and out of the drilling line, and they can also function as the rotor(s) 232a up to 232n of the braking system 230 that are operable with the one or more hydraulic disc brakes 234a, 234b up to 234n of the braking system 230 operable within the drawworks 216.

In another example, the rotating spool 220 can comprise a drum 222 having one or more flanges (typically two) supported directly adjacent the drum 222, as well as one or more rotors 232a,n (typically two) offset a distance away from the flanges, which one or more rotors 232a,n comprise and function as the one or more rotor components operable with the one or more hydraulic disc brakes (see hydraulic disc brakes 234a, 234b, . . . 234n) of the braking system 230 operable within the drawworks 216. In this example, the one or more offset rotors 232a,n are not adjacent the drum 222, and do not function to maintain the drilling line on the drum 222, but they are instead a dedicated component of the braking system 230 within the drawworks 216, and are associated with the rotating spool 220 with its drum 222 in that they are physically coupled to or formed with the rotating spool 220, namely to the drum 222 and/or the flanges directly adjacent the drum 222, and are rotatable with the rotating spool 220. In other words, they are still part of the rotatable spool 220, but their primary function is as a rotor of the braking system 230 wherein they are operable with the one or more hydraulic disc brakes 234a-n of the braking system 230 operable within the drawworks 216. One advantage of this arrangement is that the hydraulic disc brakes 234a-n can be located away from the drum 222, the flanges, and the portion of drilling line managed by the rotating spool 220. Another way of stating this arrangement is that the braking system 230 of a drawworks 216 can comprise one or more rotors 232a,n that are supported by or otherwise associated with the rotating spool 220.

As indicated above, the braking system 230 of the drawworks 216 can comprise one or more rotors (e.g., see rotors 232a and 232n, with 232n representing any number of rotors) and one or more hydraulic disc brakes (e.g., see hydraulic disc brakes 234a, 234b, and 234n, with 234 representing any number of hydraulic disc brakes), each of which can be operable with a rotor. Each hydraulic disc brake 232a, 323b, 232n can comprise a master cylinder assembly (e.g., see master cylinder assemblies 236a and 236n, respectively, with 236n representing any number of respective master cylinder assemblies) and a caliper assembly (see caliper assemblies 242a and 242n, respectively, with 242n representing any number of respective caliper assemblies) operable with the one or more rotors 232a up to 232n. In one example, the braking system 230 can comprise a single hydraulic disc brake (e.g., see hydraulic disc brake 234a) operable with a rotor (see rotor 232a), wherein the hydraulic disc brake itself comprises a master cylinder assembly (e.g., see master cylinder assembly 236a) and a caliper assembly (e.g., see caliper assembly 242a). In another example, the braking system 230 can comprise a single rotor (see rotor 232a), and a plurality of hydraulic disc brakes (e.g., see hydraulic disc brakes 234a, 234b up to 234n) operable with the single (i.e., common) rotor 232a, wherein each of the hydraulic disc brakes 234a, 234b up to 234n can comprise a respective master cylinder assembly (e.g., see respective master cylinder assemblies 236a, 236n) and a respective caliper assembly (e.g., see respective caliper assemblies 242a, 242n). In still another example, the braking system 230 can comprise a plurality of rotors (e.g., see rotors 232a up to 232n) and a plurality of hydraulic disc brakes (e.g., see hydraulic disc brakes 234a, 2324 up to 234n). Each of the hydraulic disc brakes 234a up to 234n can comprise a master cylinder assembly (e.g., see master cylinder assemblies 236a up to 236n, respectively, with 236n representing any number of respective master cylinder assemblies) and a caliper assembly (see caliper assemblies 242a up to 242n, respectively, with 242n representing any number of respective caliper assemblies). In this example, each rotor 232a, 232n can be operable with a plurality of hydraulic disc brakes 234a, 234b, 234n, respectively. For example, the braking system 230 of the drawworks 216 can comprise a first rotor 232a and a second rotor 232b, these being supported about opposing sides of the rotating spool 220. The first rotor 232a can be operable with two or more hydraulic disc brakes (e.g., see hydraulic disc brakes 234a and 234b). Likewise, the second rotor 232b can be operable with two or more hydraulic disc brakes (e.g., see hydraulic disc brakes 234c and 234d).

It is noted that the term “hydraulic disc brake” is intended to refer to an assembly or system that is part of a braking system, and that is operable with a rotor to apply a braking force to the rotor to slow or arrest rotation of the rotor and any systems or components associated with the braking system whose movement(s) is/are intended to be slowed or stopped by the braking system upon the application of a force to the rotor via the hydraulic disc brake(s). It is recognized that it may be technically accurate to define a caliper assembly of a hydraulic disc brake, or the hydraulic disc brake generally, as comprising the rotor. However, this may not always be the case when it comes to a drawworks, as a single rotor in a drawworks may be operable with a number of master cylinder assemblies and a number of corresponding caliper assemblies. Therefore, for purposes of the present disclosure, the traditional definition of a “caliper assembly” or a “hydraulic disc brake” that includes the rotor is intended to apply only to an example braking system of a drawworks that comprises a single rotor, and a single master cylinder assembly and a single caliper assembly arrangement where these are both operable with the single rotor. In other examples where a single rotor is operable with multiple different master cylinder assemblies and multiple caliper assemblies, the term “caliper assembly” and the more general term of “hydraulic disc brake” is intended to refer to the components of a hydraulic disc brake without inclusion of the rotor. This is because technically, each “hydraulic disc brake” (i.e., each master cylinder assembly and corresponding caliper assembly arrangement) is operable with the rotor, the rotor being a common rotor to each, rather than each of these comprising its own rotor. It is further noted that the term “braking system” is intended to cover both scenarios and definitions.

With regards to the example hydraulic disc brakes 234a up to 234n discussed herein that are part of the braking system 230 of the drawworks 216, although there are numerous types and designs of master cylinder assemblies that are contemplated for use herein, generally speaking, the example master cylinder assemblies 236a up to 236n of the example hydraulic disc brakes 234a up to 234n can comprise a piston assembly comprising an actuation piston, a biasing member (e.g., a spring or a spring-like device or system, such as a spring-applied hydraulic release mechanism), and a fluid reservoir. The actuation piston can be configured to apply a hydraulic force to the caliper assembly upon being actuated, whereby the caliper assembly causes the opposing brake pads to engage respective surfaces of the rotor and to apply a clamping force to the rotor. The biasing member can be sized and configured to apply a countering bias or return force to the actuation piston upon deactivating the actuation piston to cause the actuation piston to return to an initial position, thus removing the hydraulic force to the caliper assembly and facilitating the retraction of the opposing brake pads so that they disengage from the surface of the rotor, and thus removing the clamping force from the rotors.

Similarly, although there are numerous types and designs of caliper assemblies that are contemplated for use herein, generally speaking, the example caliper assemblies 242a up to 242n of the example hydraulic disc brakes 234a up to 234n can comprise a caliper, a caliper piston, and opposing brake pads operable to engage opposing outer and inner surfaces of the at least one rotor of the braking system 230. The caliper can support the opposing brake pads, and one or more caliper pistons that are operable with the opposing brake pads, and that are operable to manipulate at least one of the opposing brake pads to apply a clamping force to the at least one rotor of the braking system 230.

The drawworks 216 can further comprise a drawworks control module or system 250, which can comprise one or more computers, each computer comprising one or more microprocessors, and one or more memory storage devices, as well as a graphical user interface (GUI). The memory can be a non-transitory, tangible, computer-readable media, which can include executable instructions that can be executed by the one or more microprocessors to perform various functions associated with the operation and control of the drawworks 216.

It is noted that there are numerous types and configurations of drawworks utilizing hydraulic brakes, either as a primary braking source or as a secondary or auxiliary braking source. As such, the drawworks discussed herein and shown in the drawings are not intended to be limiting in any way. Indeed, it is contemplated that the brake sensor system 260 disclosed and discussed herein can be configured for use on any type of drawworks utilizing hydraulic brakes.

The drawworks brake performance assessment system 215 can further comprise a brake sensor system 260 operable with the braking system 230 of the drawworks 216, which can be put into operation as part a hoisting system of the drilling rig 200. The brake sensor system 260 can function to determine (i.e., measure, calculate) and indicate or convey, or facilitate the indication or conveyance, of one or more performance characteristics of the drawworks 216, and particularly the braking system 230 of the drawworks 216, for the purpose of ascertaining the status of the braking system 230, as well as for assessing how the braking system 230 will or may (e.g., an estimation) perform during a future braking event. The brake sensor system 260 functions, at a minimum, to determine one or more performance characteristics of the braking system 230, and in some examples to at least semi-automate, and in other examples fully automate, the process for checking the status, condition, and operability of the braking system 230 of the drawworks 216. In some examples, the brake sensor system 260 can further be used to determine other, more complex performance characteristics of the braking system in addition to performing more simple determinations, such as merely the distance between a brake pad and the surface of a disc of a single hydraulic disc brake operating within the drawworks 216. These can be obtained or determined via one or more calculations made by the software component of the operations module 272. Although manual brake checks or inspections of the braking system 230 of the drawworks 216 can still be performed to supplement or verify the performance characteristics determined by the brake sensor system 260, in many examples this is not required. In many cases, the brake sensor system 260 is intended to reduce, or eliminate altogether, such manual brake checks and their attendant disadvantages. However, as indicated, manual brake checks can still be conducted as needed or desired.

The brake sensor system 260 itself can comprise one or more sensors (e.g., see sensors 264a, 264b up to 264n, with 264n representing any number of sensors) operable with the braking system 230, and particularly with the one or more hydraulic disc brakes 234a, 234b, up to 234n, of the drawworks 216 to measure an aspect of the braking system 230, and to output corresponding, respective sensor data to an operations module 272, wherein the operations module 272 is operable to receive and process the sensor data to obtain and/or determine one or more performance characteristics of the braking system 230 based on the sensor data. In one example, any number or all of the one or more sensors 264a, 264b up to 264n can comprise a linear position sensor configured to measure at least one of a distance between at least one of the opposing brake pads of an associated hydraulic disc brake and a surface of the rotor 232, or to measure a displacement distance of a caliper piston of a caliper or one of the opposing brake pads supported by the caliper. This can be done at any time, or in in real-time (during a drilling operation), such as continuously, at periodic intervals (such as via a schedule), or at random times (such as after a braking event). The linear position sensor can comprise a moveable displacement component configured to generate, upon being actuated, a signal comprising sensor data. The linear position sensor can comprise a number of different types. In a specific example, the linear position sensor can comprise a high-resolution Linear Variable Differential Transformer (LVDT). In other examples, the linear position sensor can comprise at least one of a Spring-Loaded Linear Potentiometer (SLLP), a laser-based position sensor, a magnetostrictive sensor, a radar sensor, an ultrasonic sensor, a resistance-based or potentiometric sensor, a fiber-optic position sensor, an optical position sensor, a hall effect-based magnetic position sensor, a MEMS-based displacement sensor, an AI-integrated optical sensor having enhanced diagnostic and predictive capabilities, or others.

The brake sensor system 260 can further comprise a drawworks braking system interface 268 operable to support a respective sensor of the one or more sensors 264a, 264b up to 264n on a component of a respective hydraulic disc brake of the one or more hydraulic disc brakes 234a, 234b up to 234n in a proper position (i.e., a sensing position) to sense or measure the desired aspect of the braking system 230, and particularly the hydraulic disc brake with which the sensor is associated (i.e., on which the sensor is supported). The drawworks braking system interface can comprise any structure, object, system, mechanism that is attachable, integrated with, or otherwise capable of physically supporting one or more sensors on a hydraulic disc brake in a manner so as to facilitate proper operation of the one or more sensors as intended herein. In one example, the drawworks braking system interface 268 can comprise a mount or mounting assembly comprising at least one structure or structural member having a surface configured to interface with a structural component having a surface (e.g., a caliper) of the hydraulic disc brake, and at least one structure or structural interface having a surface configured to interface with the sensor, such that the sensors can be mounted on the hydraulic disc brake. In another example, the sensor can be integrally formed with one or more components of the hydraulic disc brake. The drawworks braking system interface 268 can be configured to facilitate the mechanical coupling or mounting of the sensor to a component of the hydraulic disc brake. The drawworks braking system interface 268 can be configured differently depending upon the type of sensor to be used with the hydraulic disc brake. In essence, the one or more sensors can be coupled or otherwise mounted to the hydraulic disc brake via the drawworks braking system interface 268 in any suitable manner.

In a specific example, as shown, the sensor can comprise a high-resolution Linear Variable Differential Transformer (LVDT) supported by a drawworks braking system interface 268 that couples or mounts one portion of the LVDT in a fixed manner to the hydraulic disc brake and another portion of the LVDT to a moveable portion of the hydraulic disc brake, such that the LVDT is able to operate as intended. In one example, the drawworks braking system interface 268 can comprise a bracket or bracket assembly comprising a first bracket mounted to a fixed reference portion or point of the hydraulic disc brake (e.g., a portion or component of the master cylinder assembly), and a second bracket mounted to a moveable reference portion or point of the hydraulic disc brake (e.g., a caliper arm or a caliper piston of the caliper assembly). The LVDT can be supported by (e.g., between) the first and second brackets in a manner such that the coil assembly (or cylinder) of the LVDT is supported by the first bracket, thus remaining fixed, and the moveable pushrod of the LVDT is supported by the second bracket, wherein actuation and displacement of the caliper piston causes the second bracket and the pushrod of the LVDT to likewise displace. In operation, movement of the pushrod of the LVDT operates to generate a sensor signal or sensor data in the form of an electrical current, voltage or electrical signal based on the degree of displacement (i.e., displacement distance) of the pushrod relative to the coil assembly. The sensor signal or sensor data from the sensor can be output to the operations module 272 where it can be received and processed accordingly to obtain or determine one or more performance characteristics of the braking system 230.

As indicated above, the brake sensor system 260 can further comprise an operations module (e.g., see operations module 272). The operations module 272 can comprise a computer or computing device configured to facilitate, and in some cases carry out, the functions of the brake sensor system 260. As such, the operations module 272 can comprise one or more processors 274 and one or more memory devices 276, as well as one or more software components/modules stored on the memory device(s) 276, wherein the software component(s) comprise(s) executable code or instructions facilitating the functions or processes of the brake sensor system as described herein. Specifically, the executable code or instructions can be executed by the one or more processors 274 to cause the brake sensor system to carry out its intended functions and processes. In one example, the operations module can comprise a dedicated computing device (e.g., see operations module 272). In another example, the operations module of the brake sensor system can comprise or be part of a high-level control module or system comprising a computing device, such as a drawworks control system (e.g., see operations module 272a as part of the drawworks control system 250) or a drilling rig control system (e.g., see operations module 272b as part of the drilling rig control system 204), wherein the operations module (272a or 272b) comprises the one or more processors and the one or more memory devices, as well as one or more software components stored on the memory device(s), of the computing device of the high-level control module, and wherein the software component(s) comprise(s) executable code or instructions facilitating the functions or processes of the brake sensor system as described herein.

The operations module 272 (or 272a, 272b) can be in communication with the one or more sensors 264a, 264b up to 264n of the brake sensor system 260, which at least means that the operations module 272 can receive, via at least one of a wired or wireless interface, the signals or sensor data generated by the one or more sensors 264a, 264b up to 264n as they are selectively (i.e., any one of or all can be caused to operate) caused by the operations module 272 to be in operation performing their intended sensing function. In some cases, a two-way communication can be established between the operations module 272 and the one or more sensors 264a, 264b up to 264n, such as if a signal is to be communicated to the one or more sensors 264a, 264b up to 264n (e.g., turn on/off, etc.). Once received, the operations module 272 can be configured to process the sensor data (i.e., signals) from the one or more sensors 264a, 264b up to 264n, and to determine one or more performance characteristics based on the sensor data. In one aspect, determining one or more performance characteristics can comprise determining one that is based on a directly measured aspect of the braking system (e.g., a spacing or gap distance “D” between one or more brake pads and a rotor expressed as a unit of length, a displacement of a moveable component of a linear sensor expressed as a unit of length, and others as measured directly by the one or more sensors 264a, 264b, 264c, 264d). In this aspect, the performance characteristic can be obtained from the processed sensor data that facilitates obtaining information on the very thing the sensor is intended to measure (e.g., a gap distance D between a brake pad and a rotor as measured by a LVDT sensor). The types of performance characteristics that can be determined in this aspect will largely depend upon the type of sensor being used. In another aspect, determining one or more performance characteristics can comprise determining one that is calculated or determined (e.g., derived) by a computer or computing device of the operations module, using a software module with one or more mathematical formulae or conversion functions. As such, the performance characteristic can be obtained indirectly from the sensor data of one or more sensors 264a, 264b up to 264n. Calculated or determined performance characteristics can include at least one of, but are not limited to, a clamping force, a number of times the braking system has been actuated in a given time interval, a rate of reduction of clamping force during a braking event, a rate of reduction of clamping force over a given number of braking events, the relative clamping force measurements across two or more hydraulic disc brakes within the braking system, legacy performance characteristics, such as legacy clamping force measurements, for a given brand of brake pad, the rate of wear of a given brake pad, relative comparisons of rates of wear of two or more brake pads, change in thickness of the brake pads, a frictional force based on the measured thickness of the brake pad or measured vibrations or oscillations during a braking event to detect uneven surface to surface contact between the opposing brake pads and the rotor.

The drawworks brake sensor system 260 can further comprise a notification system 278 operable with the operations module 272 to provide feedback to an operator, which feedback pertains to or is related to or is based on the sensor data obtained from the brake sensor system, and/or on one or more performance characteristics obtained directly from, or determined or calculated based on, the sensor data. Although the feedback, in some examples, can be based on a direct measurement value obtained via the one or more sensors, in other examples, the feedback can be based on the one or more calculated or determined performance characteristics of the braking system 230. The feedback can comprise any type of information that is related to the sensor data from a brake sensor system 260, including positive feedback (e.g., feedback indicating all components and systems of the braking system 230 of the drawworks 216 are okay and operating correctly and within operational constraints or specifications), or negative feedback (e.g., feedback representing a breach of a pre-determined threshold indicating improper operation or status of one or more components or systems of the braking system 230 of the drawworks 216), or any combination of these).

In one example, the notification system 278 can be configured to convey or communicate one or more directly determined performance characteristics to the operator in the form of one or more human-understandable representative expressions (a unit value, etc.) pertaining or corresponding to the one or more performance characteristics to the operator. In another example, the notification system 278 can be configured to convey or communicate to the operator, in the form of one or more human-understandable representative expressions, the results of a comparison of a current type of performance characteristic to one or more legacy or previous performance characteristics of the same type (e.g., a current distance between a brake pad and a rotor as compared with previous measurements of the same). In still another example, the notification system 278 can be configured to convey or communicate to the operator, in the form of one or more human-understandable representative expressions, the results of a comparison of a current type of performance characteristic to a pre-determined threshold of the same type of performance characteristic. The performance characteristics, the representative expressions pertaining to one or more performance characteristics, or the information based on one or more performance characteristics, that are conveyed to an operator can be referred to as “feedback” as such is conveyed or communicated back to an operator once determined. The feedback in any of these scenarios can be communicated to the operator using a notification device, such as one in the form of a display (e.g., on a graphical user interface, on a non-interactive display).

Indeed, the notification system 278 can further comprise one or more notification devices 280 operable to convey the feedback to the operator. In one example, the one or more notification devices 280 can comprise an audible device configured to provide audible feedback to the operator (e.g., an alarm, a speaker, and any others). In another example, the notification device 280 can comprise a visual device configured to provide visible feedback to the operator (e.g., a display device, a light-up display, a graphical user interface, a non-interactive display (e.g., one that displays information only) a light, and any others). In still another example, the notification device 280 can comprise a haptic device configured to provide haptic feedback to the operator (e.g., a vibration device, a tap device, and any others). In still another example, the notification system 278 can comprise a plurality of different types of notification devices 280 in any combination. The notification devices 280 can be supported by one or more components of the drilling rig 200, and can be in communication with the notification system 278, which is in communication with the operations module 272.

The following will describe various example performance characteristics that can be determined using the brake sensor system 260, and how these can be used to, depending upon the type of performance characteristic, determine or estimate the status, performance, and effectiveness of the braking system 230, which can be done at any time, or in real-time (during a drilling operation), such as continuously, at select times, at random times. As the brake pads of a hydraulic disc brake (e.g., hydraulic disc brake 234a) wear down, they experience a reduction in thickness. This reduction not only affects the distance between the brake pad and the rotor (e.g., rotor 232a), but also changes the frictional force generated during a braking event. This change directly influences the overall braking performance of the braking system 230 by potentially reducing the clamping force on the rotor 232a, which clamping force can be described as the force exerted by the caliper assembly (e.g., caliper assembly 242a) to press the brake pads against the braking surface of the rotor 232a. As a result, the braking force exerted on the rotor 232a is diminished. Frictional force, which is the force generated between the brake pads and the braking surface of the rotor 232a, plays a critical role in stopping the rotor 232a and the rotatable spool 220. Therefore, maintaining adequate brake pad thickness contributes to consistent and effective braking performance needed during operation of the system.

Incorporating a linear position sensor, such as a Linear Variable Differential Transducer (LVDT), the brake sensor system 260 can provide measurements representing the distance between the brake pads and the braking surface of the rotor 232a. Measurements can be taken at any time or in real-time during a drilling operation. From this measurement, and from knowing certain initial measurements taken using a new brake pad, the operations module 272 can determine a thickness of the brake pads, which thickness can be monitored over time. Monitoring the thickness of the brake pads and maintaining proper brake pad thickness is crucial for maintaining optimal braking efficiency. By determining and providing any time or real-time measurements and resulting corresponding feedback on brake pad wear, the sensor data from the linear position sensor, such as the LVDT, also facilitates insights into the corresponding reduction in braking force. This real-time feedback loop enables proactive maintenance of the braking system 230 of the drawworks 216, allowing for timely replacement of worn brake pads before they reach a critical thickness that compromises braking performance. Therefore, overall, the real-time monitoring of these parameters enables operators to maintain optimal braking performance and safety.

The change in thickness of the brake pads can be used to estimate the reduction in frictional force. If we denote Fᵢₙ as the initial frictional force when the brake pad thickness is t₀, and F_{worn} as the frictional force when the brake pad thickness is t_{w}, assuming a linear relationship between pad thickness and frictional force, the relationship can be expressed as:

$${F}_{worn} = tw / {t}_{0} \times {F}_{in}$$

This equation allows one to estimate the current frictional force based on the measured thickness of the brake pad. Consequently, real-time monitoring of the pad thickness provides indirect, real-time feedback on the frictional force.

While the biasing member of the caliper assembly (e.g., a spring-applied hydraulic release mechanism on some hydraulic disc brakes) compensates for some degree of pad wear by adjusting the position of the calipers, it has limitations. Even with automatic adjustments, there is a threshold beyond which the brake pads become too thin to provide effective braking. This issue can be explained using the concept of the coefficient of friction (μ), which represents the ratio of the frictional force (F) between the brake pad and the rotor to the normal force (N) exerted perpendicular to the braking surface of the rotor. Initially, when the brake pads are new and have their original thickness (t₀), they exhibit a certain coefficient of friction (μ₀). However, as they wear down or off and their thickness decreases to (t_{w}), the coefficient of friction changes to (μ_{w}). The relationship between the coefficient of friction and the frictional force can be described as:

$$F = μ \times N$$

The normal force (N) is the force exerted by the brake pads against the rotor, perpendicular to the braking surface of the rotor. Assuming a constant normal force, the frictional force (F) is directly proportional to the coefficient of friction (μ). Therefore, as the brake pads wear down, the coefficient of friction decreases (μ_{w}<μ₀), leading to a decrease in the frictional force. The clamping force (F_{c}) between the brake pads and the rotor, responsible for applying pressure to the brake pads, is not directly proportional to the frictional force. It is primarily generated by the hydraulic pressure or mechanical action that actuates the caliper assembly, causing it to squeeze the brake pads against the rotor. However, the reduction in frictional force due to worn brake pads can indirectly affect the clamping force. This relationship between the clamping force and the frictional force can be approximated by:

$$Fc = k \times F$$

where k is a constant representing the proportionality between the clamping force and the frictional force. As the frictional force (F) decreases with brake pad wear, the clamping force (F_{c}) can decrease accordingly. Therefore, as the brake pads wear off and the coefficient of friction decreases, the clamping force between the brake pads and the rotor may decrease as well. This reduction in clamping force can lead to reduced braking effectiveness and potentially longer stopping distances, emphasizing the importance of proactive brake pad monitoring and timely replacement.

Based on this, the operations module 272 can be configured to facilitate the real-time (e.g., continuous, at select intervals, at random times) monitoring of the clamping force F_{c}. In the event the clamping force F_{c} falls below a given pre-determined threshold, the operations module 272 can cause the notification system 278 to convey this to an operator in the form of feedback that also operates to activate one or more notification devices 280, such as an alarm or other warning signal. In such an instance, the operator can initiate a remedial measure, such as shutting down a drilling operation, so that a remedial action can be taken, such as changing any brake pads that need changing, adjusting any caliper assemblies that need adjusting, cleaning any brake pads that need cleaning, etc., thus placing the braking system 230 back in good working condition and remedying the breached threshold. Of course, the real-time monitoring of the clamping force F_{c} is not intended to be limiting in any way. Indeed, those skilled in the art will recognize that other performance characteristics as taught herein can be determined and monitored in real-time, as well as compared to a corresponding pre-determined threshold.

A pre-determined threshold can be arbitrarily set, can be based on a standard or specification, or can be established in any other way. In this example, the operations module 272 can compare the current performance characteristic, namely the current clamping force F_{c} value, to the established pre-determined clamping force F_{c} threshold value, which can comprise a minimum clamping force in accordance with one or more specifications, to determine if the threshold has been breached by the current value. Those skilled in the art will recognize that other performance characteristics can be compared to an established, stored threshold, such as one or more of the performance characteristics discussed herein. For example, another type of performance characteristic that can be obtained by the brake sensor system 260 is a measurement of distance between a brake pad of a hydraulic disc brake (e.g., hydraulic disc brake 234a) and a corresponding rotor (e.g., rotor 222) operable with the hydraulic disc brake 234a. A threshold distance can be established and stored and compared with real-time distance measurements obtained from current sensor data from the one or more sensors 264a, 264b, up to 264n.

The operations module 272 can further be configured to compare in real-time a plurality of currently determined performance characteristics (e.g., associated with a single hydraulic disc brake, or associated with a plurality of hydraulic disc brakes operating within the same braking system 230) to corresponding pre-determined thresholds, wherein the brake sensor system 260 operates to provide an operator with a myriad of metrics and information related to the braking performance or effectiveness of the braking system 230. Upon a breach of any one or more of such thresholds, the notification system 278 of the brake sensor system 260 can warn the operator and facilitate the carrying out of a remedial measure and a subsequent remedial action (e.g., changing the brake pads, adjusting a caliper assembly, cleaning a brake pad, etc. of a hydraulic disc brake) to place the braking system 230 back in good working condition and to remedy the breached threshold.

In one example, the operations module 272 can further be configured to automatically initiate a remedial measure, such as a temporary shut-down of a drilling operation, in response to an established pre-determined threshold of one or more performance characteristics being breached. Indeed, upon the breach of a threshold, the operations module 272, as part of or in communication with a high-level control system, can cause the high-level control system to initiate the remedial measure. The operations module 272 can cause the notification system 278 to notify the operator which threshold was breached. The automatic initiation of a remedial measure can also be based on a current performance characteristic approaching the breach of a corresponding threshold so that a remedial action can be taken before a breach occurs.

Regarding implementation configurations, in one example, the brake sensor system 260 can comprise a stand-alone system that can be fitted retroactively onto an existing drawworks, meaning one that is already manufactured but not yet in operation on a drilling rig, or one that is already in operation on a drilling rig. In this example, the brake sensor system 260, or rather at least some of the components thereof, can be mechanically coupled to the drawworks. By “stand-alone” it is meant that the brake sensor system 260 can comprise at least some, and in some examples all, of the necessary components (e.g., sensor(s), operations module or computer, graphical user interface, notification system, etc.) to control and operate the brake sensor system 260 and to obtain and/or determine one or more performance characteristics of the drawworks, which components can be considered “dedicated” components, meaning that they are specifically part of the build of the brake sensor system 260 and are not part of any components or systems of the drawworks 216 or the drilling rig 200. In one aspect, a stand-alone brake sensor system 260 that is fitted retroactively onto an existing drawworks 216 can comprise all of the necessary and dedicated components for operation with the drawworks 216. For example, one or more sensors (e.g., sensors 264a, 264b) can be mounted to a brake system 230 of the drawworks 216, which sensors can be electrically connected to and in communication with the dedicated operations module 272, which can be electrically connected to an in communication with a dedicated graphical user interface 284 and a dedicated notification system 278, wherein none of the components, modules or systems of the brake sensor system 260 are integrated into any high-level control system of the drawworks 216 or the drilling rig 200.

In another aspect, a stand-alone brake sensor system 260 can be both mechanically coupled to the drawworks, as well as electrically integrated into at least one of the drawworks 216 or the drilling rig 200 to some extent. Electrical integration of the stand-alone brake sensor system 260 can comprise electrically interfacing the brake sensor system 260 with an existing high-level control system of at least one of the drawworks 216 or the drilling rig 200 (e.g., with a drawworks control system 250 of the drawworks 216 itself, with a drilling rig control system 204, or both of these depending upon availability and/or preference), meaning that the brake sensor system 260 can be operated and controlled via the high-level control system. For example, one or more sensors (e.g., sensors 264a, 264b) can be mounted to a brake system 230 of the drawworks 216, which sensors can be electrically connected to and in communication with the operations module 272. In this example, the operations module 272 can comprise a dedicated operations module or the operations module 272 can be part of an existing high-level control system of at least one of the drawworks 216 or the drilling rig 200. Also, in this example the graphical user interface can comprise a dedicated GUI 284, or at least one of the graphical user interface 258 of the drawworks control system 250 or the graphical user interface 206 of the drilling rig control system 204, or any combination of these. In an example arrangement where at least some of the brake sensor system 260 components are integrated into at least one of the drawworks 216 or the drilling rig 200, the brake sensor system 260 can further comprise a high-level control system interface 288 configured to facilitate integration of the one or more components of the brake sensor system 260 (e.g., the operations module) into a high-level control system, namely by facilitating communication of the one or more integrated components and the high-level control system with other components of the brake sensor system 260 (e.g., the sensors 264a, 264b, 264n). A high-level control system can comprise, but is not limited to, the drawworks control system 250 of the drawworks 216 itself, the drilling rig control system 204 of the drilling rig 200, or both of these. The high-level control system interface 288 can comprise both mechanical interfaces, (e.g., connectors, wires, electronics devices, etc.), electrical interfaces (e.g., wired or wireless communications devices), or a combination of these. In connection with this, the high-level control system can comprise a brake sensor system interface in communication with the high-level control system interface 288 to facilitate transfer of data between various components of the brake sensor system 260 and the high-level control system.

In another example, the brake sensor system 260 can be integrally formed with the drawworks 216, and particularly with the braking system 230 of the drawworks, meaning that the brake sensor system 260 comprises a system of components that are part of the initial build of the drawworks 216. In this example, the brake sensor system 260 may or may not comprise, although it could (e.g., to achieve a level of redundancy), all or some of the same “dedicated” components that a stand-alone brake sensor system may comprise. For example, the brake sensor system 260 that is integrally formed with an initial build of the drawworks 216 may or may not comprise a dedicated graphical user interface 284 or a dedicated operations module 272, as these can be included in and part of a high-level control system, such as a drawworks control system 250, with a drilling rig control system 204, or both of these. Similar to the example above of a stand-alone brake sensor system with at least some of its components integrated with a high-level control system, the brake sensor system 260 that is initially integrally formed with the drawworks 216 can further comprise a high-level control system interface 288 configured to facilitate integration of one or more components of the brake sensor system 260 into the high-level control system, such as the drawworks control system 250 of the drawworks 216 itself, the drilling rig control system 204 of the drilling rig 200, or both of these, where the high-level control interface 288 is configured to facilitate communication between the various components of the brake sensor system 260 and the high-level control system. As an example, the brake sensor system 260 can still comprise an operations module 272 having a software component, but the processor(s) and memory can comprise the processor(s) and memory of the high-level control system. In addition, the high-level control system can comprise a brake sensor system interface in communication with the high-level control system interface 288 to facilitate transfer of data between various components of the brake sensor system 260 and the high-level control system.

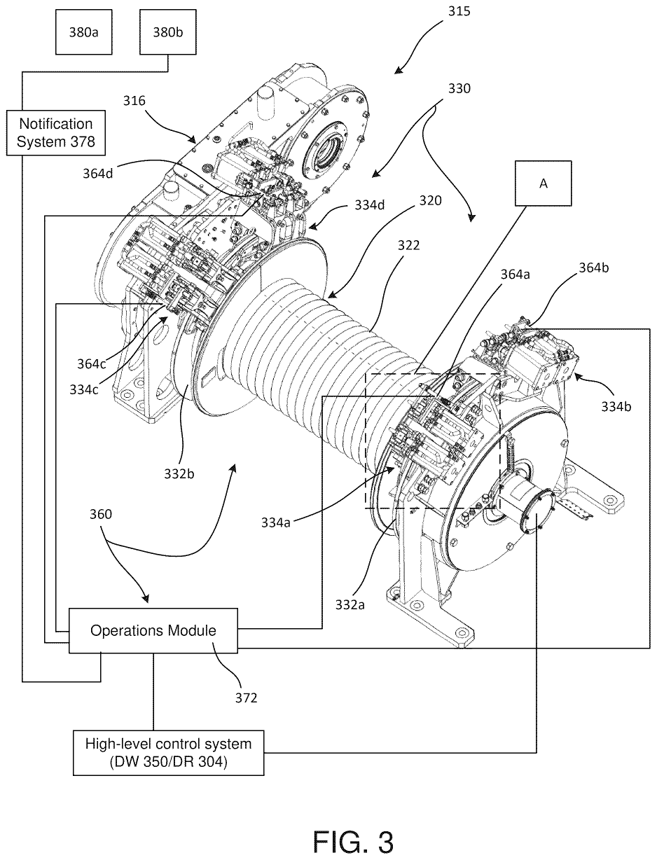

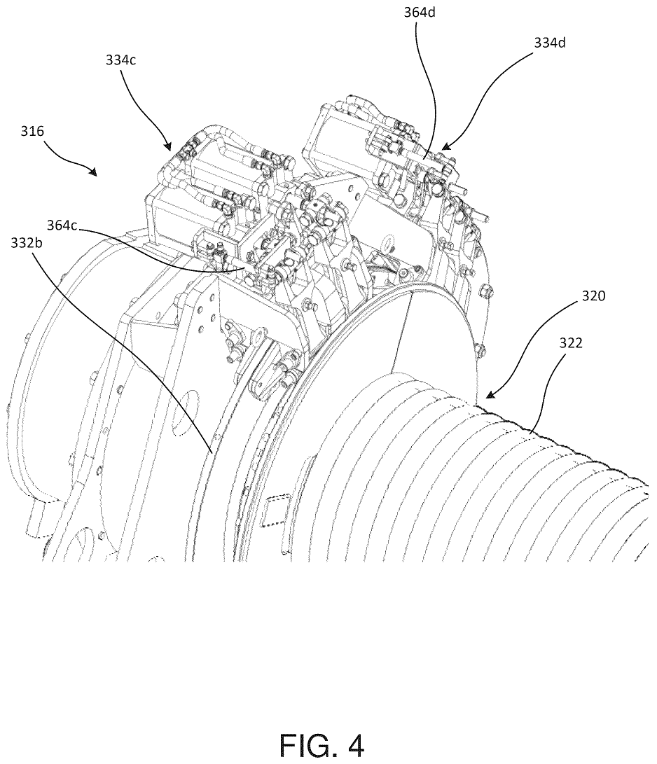

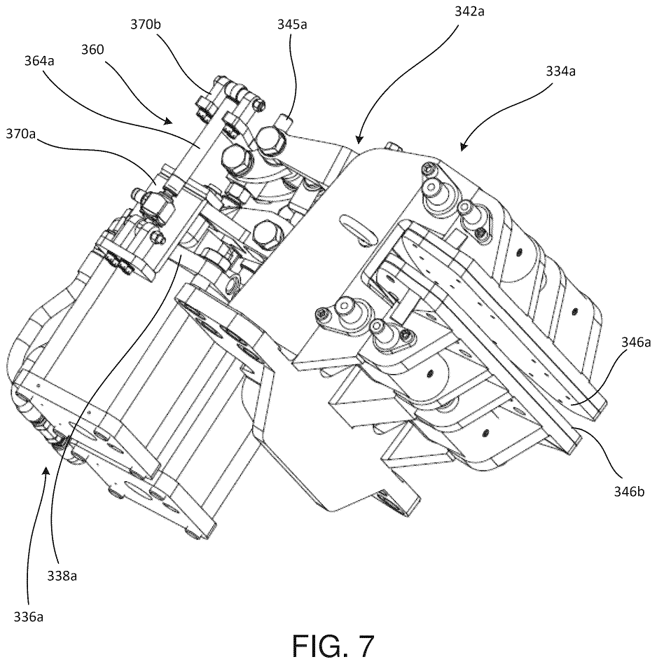

With reference to FIGS. 3-7, illustrated is a more specific yet exemplary drawworks and a more specific yet exemplary brake sensor system of the exemplary drawworks brake performance assessment system of FIG. 2, thus illustrating an example implementation of the drawworks brake performance assessment system of FIG. 2 in accordance with an example of the present disclosure. The above teachings with respect to FIG. 2 are intended to be referred to for any additional understanding of the example embodiment of FIGS. 3-7. Indeed, for the sake of brevity, the drawworks brake performance assessment system is not explained in as great a detail as it is in FIG. 2. Therefore, the below discussion of FIGS. 3-7 should be read in conjunction with the teachings above as pertaining to FIG. 2.

As shown, the exemplary drawworks brake performance assessment system 315 can comprise a drawworks 316 comprising a rotatable spool 320 having a drum 322 and opposing flanges supported on first and second ends of the drum 322. The drawworks 316 can further comprise a first rotor 332a and a second rotor 332b associated with the rotatable spool 320, such that the first and second rotors 332a, 332b rotate with the rotatable spool 320.

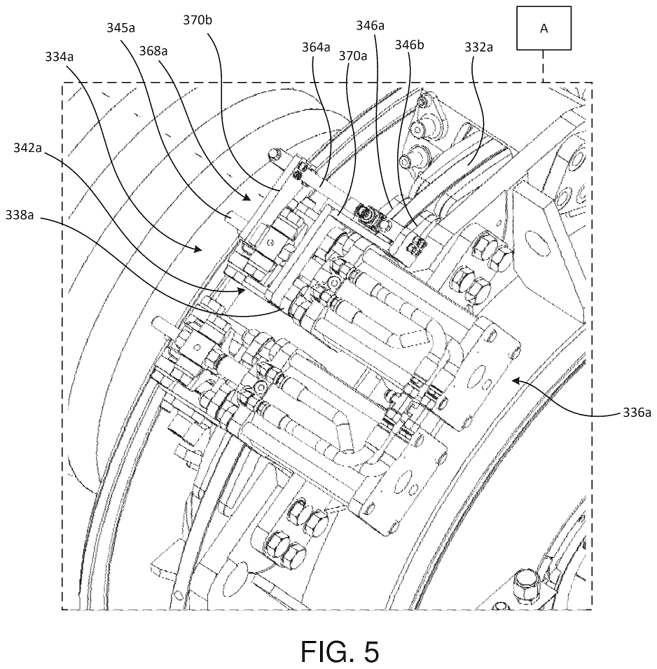

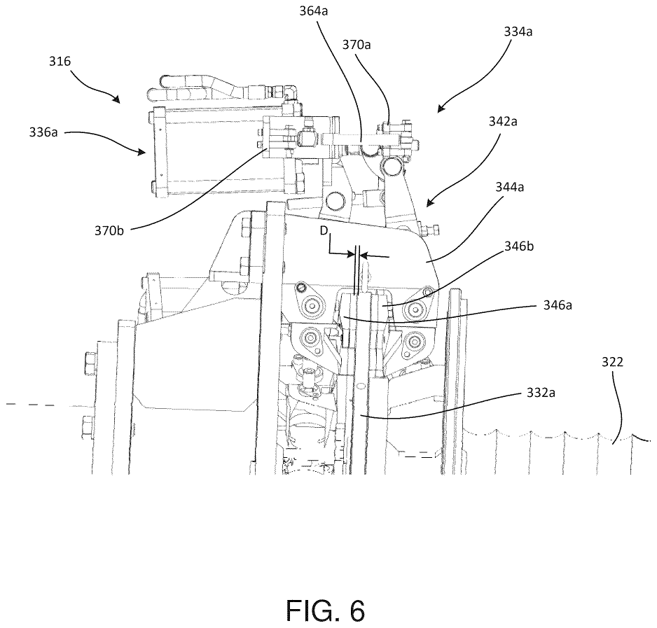

The drawworks 316 can further comprise a plurality of hydraulic disc brakes, namely a first hydraulic disc brake 334a and a second hydraulic disc brake 334b operable with the first rotor 332a, and a third hydraulic disc brake 334c and a fourth hydraulic disc brake 334d operable with the second rotor 332b. Each hydraulic disc brake can comprise a master cylinder assembly (e.g., see master cylinder assembly 336a in FIGS. 5 and 6), and a caliper assembly (e.g., see caliper assembly 342a in FIGS. 5 and 6). Each master cylinder assembly can comprise a piston assembly comprising an actuation piston, a biasing member (e.g., a spring or a spring-like device or system, such as a spring-applied hydraulic release mechanism), and a fluid reservoir (e.g., one having an actuation piston operable with a spring-applied hydraulic release mechanism). The actuation piston can be configured to apply a hydraulic force to the caliper assembly upon being actuated, whereby the caliper assembly causes the opposing brake pads to engage respective surfaces of the rotor and to apply a clamping force to the rotor. Each caliper assembly can comprise a caliper, a caliper piston, and opposing brake pads supported by the caliper and operable to engage respective opposing outer and inner braking surfaces of the rotor 332a of the braking system 330 (e.g., see caliper 344a, caliper piston 345a, and opposing brake pads 346a and 346b of the first hydraulic disc brake 334a in FIG. 5 or 6).

The drawworks brake performance assessment system 315 can further comprise a brake sensor system 360 comprising a first sensor 364a operable with the first hydraulic disc brake 334a, a second sensor 364b operable with the second hydraulic disc brake 334b, a third sensor 364c operable with the third hydraulic disc brake 334c, and a fourth sensor 364d operable with the fourth hydraulic disc brake 334d. In the example shown, each of the sensors comprises a LVDT sensor, but this is not intended to be limiting in any way.

The brake sensor system 360 can further comprise a plurality of drawworks braking system interfaces. In this example, the brake sensor system 360 can comprise four drawworks braking system interfaces, each in the form of bracket assemblies comprising a first bracket and a second bracket operable to interface with a hydraulic disc brake and to support a respective sensor in a strategic position on a respective hydraulic disc brake so as to be able to measure the intended aspect of the braking system 330. For instance, the brake sensor system 360 can comprise a first bracket assembly 368a operable with the first hydraulic disc brake 334a, and comprising a first bracket 370a and a second bracket 370b. The first bracket 370a can be coupled to a fixed reference point, such as on a support member 338a of the master cylinder assembly 336a of the first hydraulic disc brake 334a, and the second bracket 370b can be coupled to a moveable reference point, such as on a caliper piston 345a of the caliper assembly 342a. The first bracket 370a can be coupled to a fixed end of the sensor 364a (e.g., to a coil assembly (or cylinder) of the LVDT sensor), and the second bracket 370b can be coupled to a moveable component of the sensor 364a (e.g., to a pushrod of the LVDT sensor), thus strategically positioning the LVDT sensor to be able to measure a stroke length or displacement of the pushrod of the LVDT sensor during a braking event, as well as the distance between one of the opposing brake pads and a braking surface of the rotor 332a.

The brake sensor system 360 can further comprise an operations module 372 in communication with each of the first, second, third, and fourth sensors 364a, 364b, 364c, and 364d, respectively. The operations module 372 can be a dedicated operations module, or it can be integrated into a high-level control system, such as a drawworks control system 350 and/or a drilling rig control system 304.

The brake sensor system 360 can further comprise a notification system 378 comprising one or more notification devices (see notification devices 380a and 380b of FIG. 3). The notification system 378 can be in communication with the operations module 372.

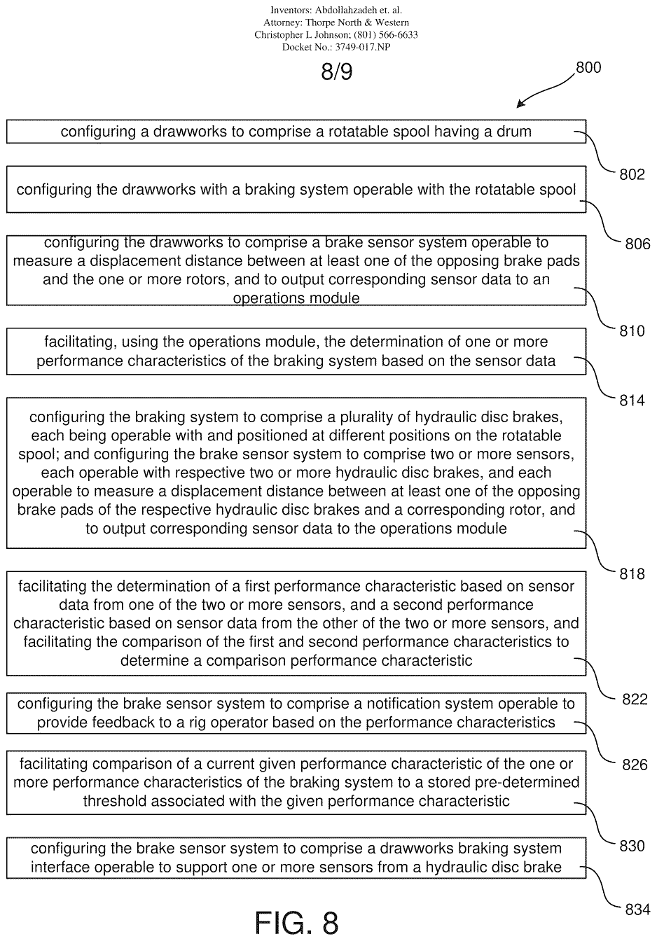

With reference to FIG. 8, the present disclosure further sets forth a method 800 and drawworks brake performance assessment system for facilitating the determination, in real-time, of one or more performance characteristics of a braking system of a drawworks, such as those described above, of a drilling rig during a drilling operation. The drawworks brake performance assessment system can comprise any of the exemplary drawworks brake performance assessment systems set forth in the drawings and described above. The drawworks with its braking system can comprise any of the exemplary drawworks and braking systems set forth in the drawings and described above. Likewise, the drilling rig can comprise the exemplary drilling rigs set forth in the drawings and described above.

The method 800 can comprise, at step 802, configuring a drawworks to comprise a rotatable spool having a drum. The rotatable spool can comprise one or more flanges, which, in some examples, can comprise a rotor operable with one or more hydraulic disc brakes.

The method 800 further comprises, at step 806, configuring the drawworks with a braking system operable with the rotatable spool. The braking system can comprise at least one rotor, which can be configured as taught herein with respect to the drawworks brake performance assessment system discussed above, the rotor being operable with at least one hydraulic disc brake. The at least one hydraulic brake can comprise a master cylinder assembly and a caliper assembly, each of which can be configured as taught herein with respect to the drawworks brake performance assessment system discussed above. The caliper assembly can comprise a caliper and opposing brake pads supported by the caliper and operable to engage the rotor, wherein the master cylinder assembly is operable with the caliper assembly to manipulate at least one of the opposing brake pads to apply a clamping force to the rotor.

The method 800 can further comprise, at step 810, configuring the drawworks to comprise a brake sensor system, which can be configured as taught herein with respect to the drawworks brake performance assessment system discussed above, operable to measure a displacement distance between at least one of the opposing brake pads and the one or more rotors, and to output corresponding sensor data to an operations module. The braking system can comprise one or more sensors operable to perform the measurement.

The method 800 can further comprise, at step 814, facilitating, using the operations module, the determination of one or more performance characteristics of the braking system based on the sensor data.

The method 800 can further comprise, at step 818, configuring the braking system to comprise a plurality of hydraulic disc brakes, which can be configured as taught herein with respect to the drawworks brake performance assessment system discussed above. Each of the hydraulic disc brakes can be operable with and positioned at different positions on the rotatable spool. A part of this step, the method can further comprise configuring the brake sensor system to comprise two or more sensors, each operable with respective two or more hydraulic disc brakes of the plurality of hydraulic disc brakes, and each operable to measure a displacement distance between at least one of the opposing brake pads of the respective hydraulic disc brakes and a corresponding rotor, and to output corresponding sensor data to the operations module.

The method 800 can further comprise, at step 822, facilitating the determination of a first performance characteristic based on sensor data from one of the two or more sensors, and a second performance characteristic based on sensor data from the other of the two or more sensors, and facilitating the comparison of the first and second performance characteristics to determine a comparison performance characteristic.

The method 800 can further comprise, at step 826, configuring the brake sensor system to comprise a notification system, which can be configured as taught herein with respect to the drawworks brake performance assessment system discussed above, operable to provide feedback to a rig operator based on the performance characteristics of the braking system.

The method 800 can further comprise, at step 830, facilitating comparison of a current given performance characteristic of the one or more performance characteristics of the braking system to a stored pre-determined threshold associated with the given performance characteristic, and providing the feedback to the rig operator indicative of the current given performance characteristic breaching the threshold.

The method 800 can further comprise configuring the caliper assembly to further comprise a caliper piston supported by the caliper, and opposing brake pads supported by the caliper, the caliper piston being operable to manipulate at least one of the opposing brake pads to apply a clamping force to the at least one rotor.

The method 800 can further comprise configuring the brake sensor system to comprise a linear position sensor.

The method 800 can further comprise configuring the brake sensor system to comprise a Linear Variable Differential Transformer (LVDT).

The method 800 can further comprise comprising configuring the operations module of the brake sensor system to be integrated with a high-level control system interface, which can be done as taught herein with respect to the drawworks brake performance assessment system discussed above.

The method 800 can further comprise, at step 834, configuring the brake sensor system to comprise a drawworks braking system interface, which can be configured as taught herein with respect to the drawworks brake performance assessment system discussed above, operable to support one or more sensors from the at least one hydraulic disc brake.

The braking system and the brake sensor system used in the above-described method 800 can together form a drawworks brake performance assessment system, such as those described above.

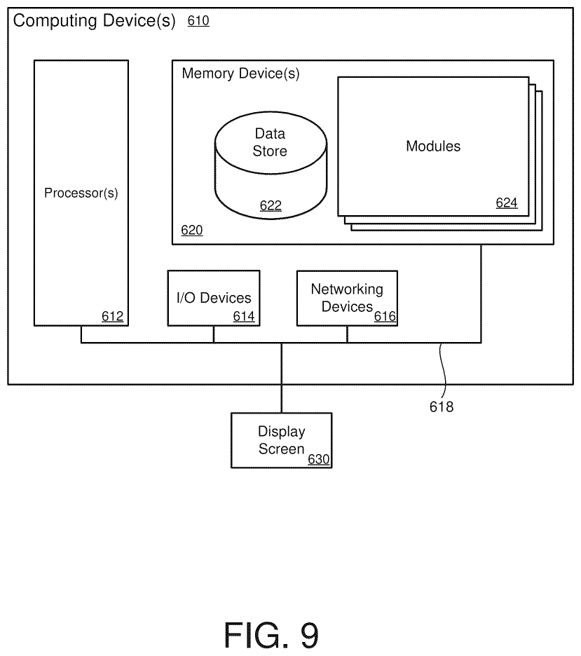

FIG. 9 illustrates a computer or computing device 610 on which software components of the systems or modules of the present technology described herein may be executed. For example, the computer or computing device 610 can represent the computing device of the operations module (e.g., see operations modules 272, 272a, 272b, 372), the drawworks control system 250, 350, and/or the drilling rig control system 204, 304 discussed herein. The computing device 610 can include one or more processors 612 that are in communication with one or more memory devices 620. The computing device 610 may include a local communication interface 618 for the components in the computing device. For example, the local communication interface 618 may be a local data bus and/or any related address or control busses as may be desired.

The memory device 620 may contain software modules 624 that are executable by the processor(s) 612 and data for the modules 624. For example, the memory device 620 may include respective software components that are part of a control system or module (e.g., the operations module, the control system local to the brake sensor system, or a high-level control system such as the drawworks control system or the drilling rig control system made operable with the brake sensor system), a determination or computational module, a notification module and others to enable implementation and use of the above-described technology. The software modules 624 may execute the functions or processes as described herein. A data store 622 may also be located in the memory device 620 for storing data related to the software modules 624 and other applications along with an operating system that is executable by the processor(s) 612.

Other applications may also be stored in the memory device 620 and may be executable by the processor(s) 612. Components or modules discussed in this description can be implemented in the form of software using high-level programming languages that are compiled, interpreted or executed using a hybrid of the methods.

The computing device 610 can also have access to I/O (input/output) devices 614 that are usable by the computing device 610. An example of an I/O device 614 is a display screen 630 that is available to display output from the computing device 610. Another example of an I/O device 614 is one or more notification devices of a notification system (e.g., an audible device, a visual device, a haptic device), and any other I/O devices associated with a brake sensor system of the present disclosure. Networking devices 616 and similar communication devices may be included in the computing device. The networking devices 616 may be wired or wireless networking devices that connect to the internet, a LAN, WAN, or other computing network.

The components or modules that are shown as being stored in the memory device 620 may be executed by the processor(s) 612. The term “executable” may mean a program file that is in a form that may be executed by a processor 612. For example, a program in a higher-level language may be compiled into machine code in a format that may be loaded into a random-access portion of the memory device 620 and executed by the processor 612, or source code may be loaded by another executable program and interpreted to generate instructions in a random-access portion of the memory to be executed by a processor. The executable program may be stored in any portion or component of the memory device 620. For example, the memory device 620 may be random access memory (RAM), read only memory (ROM), flash memory, a solid-state drive, memory card, a hard drive, optical disk, floppy disk, magnetic tape, or any other memory components.

The processor 612 may represent multiple processors and the memory device 620 may represent multiple memory units that operate in parallel to the processing circuits. This may provide parallel processing channels for the processes and data in the system. The local communication interface 618 may be used as a network to facilitate communication between any of the multiple processors and multiple memories. The local communication interface 618 may use additional systems designed for coordinating communication such as load balancing, bulk data transfer and similar systems.

Some of the functional units described in this specification have been labeled as modules or systems, in order to more particularly emphasize their implementation independence. For example, a module or system may comprise at least some mechanical, structural or electrical devices, as well as a software component or software module. Modules can further comprise, in part, a hardware circuit comprising custom VLSI circuits or gate arrays, off-the-shelf semiconductors such as logic chips, transistors, or other discrete components. A module may also be implemented in or comprise programmable hardware devices such as field programmable gate arrays, programmable array logic, programmable logic devices or the like.

Modules may also be implemented in or comprise a software component or software module for execution by various types of processors. An identified software module of executable code may, for instance, comprise one or more blocks of computer instructions, which may be organized as an object, procedure, or function.

Nevertheless, the executables of an identified software module need not be physically located together, but may comprise disparate instructions stored in different locations which comprise the software module and achieve the stated purpose for the software module when joined logically together.

Indeed, a software module of executable code may be a single instruction, or many instructions and may even be distributed over several different code segments, among different programs and across several memory devices. Similarly, operational data may be identified and illustrated herein within software modules and may be embodied in any suitable form and organized within any suitable type of data structure. The operational data may be collected as a single data set, or may be distributed over different locations including over different storage devices. The software modules may be passive or active, including agents operable to perform desired functions.

The software portions of the technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine-readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

The following examples are further illustrative of several embodiments of the present technology:

1. A drawworks brake performance assessment system operable within a drill rig for determining, in real-time, braking performance of a braking system of a drawworks during a drilling operation, the system comprising:
a drawworks comprising:
a rotatable spool having a drum operable to receive a drilling line; and
a braking system comprising at least one rotor and at least one hydraulic disc brake, the at least one rotor being associated with the rotatable spool such that the at least one rotor rotates with the rotation of the rotatable spool, the at least one hydraulic disc brake comprising:
a master cylinder assembly;
a caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor; and
a brake sensor system comprising a sensor and an operations module, the sensor being operable with the hydraulic disc brake of the braking system of the drawworks to measure a displacement distance between at least one of the opposing brake pads and a surface of the rotor, and to output corresponding sensor data to the operations module, wherein the operations module comprises a computing device operable to receive and process the sensor data and to determine one or more performance characteristics of the braking system based on the sensor data.

2. The drawworks brake performance assessment system of example 1, wherein the braking system of the drawworks comprises a plurality of hydraulic disc brakes, including the at least one hydraulic disc brake, each of the plurality of hydraulic disc brakes being operable with and positioned at different positions on the rotor, and wherein the brake sensor system comprises two or more sensors, each operable with a respective hydraulic disk brake of the plurality of hydraulic disc brakes, and each operable to measure a displacement distance between at least one of the opposing brake pads of the respective hydraulic disc brake and the rotor, and to output corresponding sensor data to the operations module.

3. The drawworks brake performance assessment system of any one or more preceding examples, wherein the one or more performance characteristics of the braking system comprises a first performance characteristic based on sensor data from one of the two or more sensors, and a second performance characteristic based on sensor data from the other of the two or more sensors.

4. The drawworks brake performance assessment system of any one or more preceding examples, wherein the first and second performance characteristics are comparable to determine a comparison performance characteristic.

5. The drawworks brake performance assessment system of any one or more preceding examples, wherein the one or more performance characteristics of the braking system comprises a unit of measurement representative of a directly measured aspect of the braking system.

6. The drawworks brake performance assessment system of any one or more preceding examples, wherein the one or more performance characteristics of the braking system is determined by the computing device, and is based on the sensor data from a single sensor operating on a single hydraulic disc brake.

7. The drawworks brake performance assessment system of any one or more preceding examples, wherein the brake sensor system further comprises a notification system operable to provide feedback to a rig operator based on the one or more performance characteristics of the braking system, the notification system comprising at least one notification device.

8. The drawworks brake performance assessment system of any one or more preceding examples, wherein the notification device comprises at least one of an audible device configured to provide audible feedback, a visual device configured to provide visible feedback, or a haptic device configured to provide haptic feedback.

9. The drawworks brake performance assessment system of any one or more preceding examples, wherein the computing device of the operations module is operable to compare a current given performance characteristic of the one or more performance characteristics of the braking system to a stored pre-determined threshold associated with the given performance characteristic, and to provide feedback to the rig operator in the form of a warning based on the current given performance characteristic breaching the threshold.

10. The drawworks brake performance assessment system of any one or more preceding examples, wherein the sensor comprises a linear position sensor.

11. The drawworks brake performance assessment system of any one or more preceding examples, wherein the sensor comprises a Linear Variable Differential Transformer (LVDT).

12. The drawworks brake performance assessment system of any one or more preceding examples, wherein the operations module is integrated with and part of a high-level control system.

13. The drawworks brake performance assessment system of any one or more preceding examples, wherein the rotor comprises a flange of the rotatable spool.

14. The drawworks brake performance assessment system of any one or more preceding examples, wherein the brake sensor system further comprises a high-level control system interface.

15. The drawworks brake performance assessment system of any one or more preceding examples, further comprising a high-level control system operable to control operation of the drawworks and the braking system of the drawworks, the high-level control system comprising a brake sensor system interface in communication with the high-level control system interface to facilitate transfer of data between one or more components of the brake sensor system and the high-level control system.

16. The drawworks brake performance assessment system of any one or more preceding examples, further comprising a braking system interface operable to support the sensor on the hydraulic disc brake in a proper sensing position.

17. The drawworks brake performance assessment system of any one or more preceding examples, wherein the braking system interface comprises a bracket assembly.

18. The drawworks brake performance assessment system of any one or more preceding examples, wherein the bracket assembly comprises a first bracket mounted to a fixed reference point of the hydraulic disc brake and a fixed portion of the sensor, and a second bracket mounted to a moveable reference point of the hydraulic disc brake and to a moveable portion of the sensor.

19. A drawworks operable within a drilling rig, the drawworks comprising:
a rotatable spool having a drum; and
a braking system comprising:
a rotor associated with the rotatable spool such that the at least one rotor rotates with the rotation of the rotatable spool;
a first hydraulic disc brake comprising a master cylinder assembly, and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor;
a second hydraulic disc brake comprising a master cylinder assembly, and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor; and a brake sensor system operable with the braking system, and comprising first and second sensors and an operations module,
wherein the first sensor is operable with the first hydraulic disc brake of the braking system to measure a displacement distance of one of the opposing brake pads and the rotor, and to output corresponding sensor data,
wherein the second sensor is operable with the second hydraulic disc brake of the braking system to measure a displacement distance of one of the opposing brake pads and the rotor, and to output corresponding sensor data
wherein the operations module comprises a computing device operable to receive the sensor data from the first and second sensors and to determine one or more performance characteristics of the braking system based on the sensor data.

20. The drawworks of any one or more preceding examples, wherein the first and second hydraulic disc brakes are operable with and positioned at different positions on the rotor.

21. The drawworks of any one or more preceding examples, wherein the one or more performance characteristics of the braking system comprises a first performance characteristic based on sensor data from the first sensor, and a second performance characteristic based on sensor data from the second sensor.

22. The drawworks of any one or more preceding examples, wherein the first and second performance characteristics are comparable to determine a comparison performance characteristic.

23. The drawworks of any one or more preceding examples, wherein the one or more performance characteristics of the braking system comprises a unit of measurement representative of a directly measured aspect of the braking system.

24. The drawworks of any one or more preceding examples, wherein the one or more performance characteristics of the braking system is determined by the computing device, and based on the sensor data from a single sensor operating on a single hydraulic disc brake.

25. The drawworks of any one or more preceding examples, wherein the brake sensor system further comprises a notification system operable to provide feedback to a rig operator based on the performance characteristics of the braking system.

26. The drawworks of any one or more preceding examples, wherein the notification system comprises at least one of an audible system configured to provide audible feedback, a visual system configured to provide visible feedback, or a haptic system configured to provide haptic feedback.

27. The drawworks of any one or more preceding examples, wherein the computing device of the operations module is operable to compare a current given performance characteristic of the one or more performance characteristics of the braking system to a stored pre-determined threshold associated with the given performance characteristic, and to provide the feedback to the rig operator based on the current given performance characteristic breaching the threshold.

28. The drawworks of any one or more preceding examples, wherein the sensor comprises a linear position sensor.

29. The drawworks of any one or more preceding examples, wherein the sensor comprises a Linear Variable Differential Transformer (LVDT).

30. The drawworks of any one or more preceding examples, wherein the operations module is integrated with and part of a high-level control system.

31. The drawworks of any one or more preceding examples, wherein the at least one disc is integrally formed with the drum.

32. The drawworks of any one or more preceding examples, wherein the brake sensor system further comprises a high-level control system interface.

33. The drawworks of any one or more preceding examples, further comprising a high-level control system operable to control operation of the drawworks and the braking system of the drawworks, the high-level control system comprising a brake sensor system interface in communication with the high-level control system interface to facilitate transfer data between one or more components of the brake sensor system and the high-level control system.

34. A brake sensor system operable with a drawworks of a drilling rig, the brake sensor system comprising:
a plurality of sensors, each operable with a respective hydraulic disc brake of a braking system of a drawworks of a drilling rig, wherein each respective hydraulic disc brake comprises a master cylinder assembly, and a caliper assembly, the caliper assembly comprising a caliper and opposing brake pads supported by the caliper and operable to engage a rotor, wherein the master cylinder assembly is operable with the caliper assembly to manipulate at least one of the opposing brake pads to apply a clamping force to the rotor;
a plurality of braking system interfaces, each comprising a mounting assembly operable to support a sensor of the plurality of sensors on a respective hydraulic disc brake in a position suitable for measuring a displacement distance between at least one of the opposing brake pads and the rotor, and to output corresponding sensor data; and
an operations module comprising at least one processor, and one or more memory devices including instructions that, when executed by the at least one processor, cause the system to:
selectively operate the plurality of sensors, each sensor configured to measure a displacement distance between the rotor and at least one of the opposing brake pads of a hydraulic disc brake of the plurality of hydraulic disc brakes; receive the sensor data from one or more sensors of the plurality of sensors; determine one or more performance characteristics of the braking system of the drawworks based on the sensor data; and
communicate the one or more performance characteristics to an operator.

35. The system of any one or more preceding examples, further comprising a notification system comprising at least one notification device, the notification system being operable with the operations module to communicate the one or more performance characteristics to an operator.

36. The system of any one or more preceding examples, wherein the one or more memory devices further includes instructions that, when executed by the at least one processor, cause the system to:
access a stored, pre-determined threshold value associated with a given performance characteristic of the one or more performance characteristics of the braking system;
compare a current value of the given performance characteristic to the stored, pre-determined threshold value; and
provide feedback to the operator in the form of a warning based on the current value of the given performance characteristic breaching the threshold value.

37. The system of any one or more preceding examples, wherein the one or more performance characteristics comprises a clamping force of the respective hydraulic disc brake.

38. The system of any one or more preceding examples, wherein the operations module comprises a dedicated computer.

39. The system of any one or more preceding examples, wherein the operations module is configured to be integrally formed with a high-level control system of at least one of the drawworks or a drilling rig in which the drawworks operates.

40. The system of any one or more preceding examples, wherein the sensor comprises a Linear Variable Differential Transformer (LVDT).

41. The system of any one or more preceding examples, wherein the one or more performance characteristics comprises one that is calculated and obtained indirectly from the sensor data.

42. The system of any one or more preceding examples, wherein the one or more performance characteristics comprises a comparison performance characteristic obtained indirectly from the sensor data from at least two sensors and at least two corresponding hydraulic disc brakes operable within the braking system of the drawworks.

43. The system of any one or more preceding examples, wherein the plurality of sensors are each supported on a different respective hydraulic disc brake operable with the rotor, and wherein the one or more performance characteristics is based on a relative comparison of sensor data from at least two of the plurality of sensors.

44. The system of any one or more preceding examples, wherein the one or more memory devices further includes instructions that, when executed by the at least one processor, cause the system to:
receive sensor data from two or more sensors of the plurality of sensors associated with respective two or more hydraulic disc brakes operating within the braking system; and
determine a plurality of performance characteristics of the braking system based on the sensor data from the two or more sensors.

45. The system of any one or more preceding examples, wherein the operations module is integrated with and part of a high-level control system.

46. The system of any one or more preceding examples, wherein the plurality of braking system interfaces each comprise a mounting assembly operable to mount, at least in part, to a caliper of a respective hydraulic disc brake, wherein the mounting assembly is configured to support a sensor of the plurality of sensors.

47. A method for facilitating the determination, in real-time, of one or more performance characteristics of a braking system of a drawworks of a drilling rig during a drilling operation, the method comprising:
configuring a drawworks with a rotatable spool having a drum;
configuring the drawworks with a braking system operable with the rotatable spool, the braking system comprising at least one rotor operable with at least one hydraulic disc brake comprising a master cylinder assembly and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor;
configuring the drawworks to comprise a brake sensor system operable to measure a displacement distance between at least one of the opposing brake pads and the one or more rotors, and to output corresponding sensor data to an operations module; and
facilitating the determination of one or more performance characteristics of the braking system based on the sensor data.

48. The method of any one or more preceding examples, further comprising: configuring the braking system to comprise a plurality of hydraulic disc brakes, each being operable with and positioned at different positions on the rotor; and configuring the brake sensor system to comprise two or more sensors, each operable with a respective hydraulic disc brake of the plurality of hydraulic disc brakes, and each operable to measure a displacement distance between at least one of the opposing brake pads of the respective hydraulic disc brakes and the at least one rotor, and to output corresponding sensor data to the operations module.

49 The method of any one or more preceding examples, further comprising facilitating the determination of a first performance characteristic based on sensor data from one of the two or more sensors, and a second performance characteristic based on sensor data from the other of the two or more sensors.

50. The method of any one or more preceding examples, further comprising facilitating the comparison of the first and second performance characteristics to determine a comparison performance characteristic.

51. The method of any one or more preceding examples, further comprising configuring the brake sensor system to comprise a notification system operable to provide feedback to a rig operator based on at least one of the sensor data or the one or more performance characteristics.

52. The method of any one or more preceding examples, further comprising facilitating comparison of a current given performance characteristic of the one or more performance characteristics to a stored, pre-determined threshold corresponding to the given performance characteristic, and providing the feedback to the rig operator in the form of a warning indicative of the current given performance characteristic breaching the threshold.

53. The method of any one or more preceding examples, further comprising configuring the caliper assembly to further comprise a caliper piston supported by the caliper, the caliper piston being operable to manipulate at least one of the opposing brake pads to apply a clamping force to the at least one rotor.

54. The method of any one or more preceding examples, further comprising configuring the brake sensor system to comprise a sensor in the form of a linear position sensor.

55. The method of any one or more preceding examples, further comprising configuring the brake sensor system to comprise a sensor in the form of a Linear Variable Differential Transformer (LVDT).

56. The method of any one or more preceding examples, further comprising configuring the operations module of the brake sensor system to be integrated with a high-level control system interface.

57. The method of any one or more preceding examples, further comprising configuring the brake sensor system to comprise a drawworks braking system interface operable to support one or more sensors from the at least one hydraulic disc brake.

58. The method of any one or more preceding examples, wherein the braking system and the brake sensor system form a drawworks brake performance assessment system.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features or examples described herein may be combined with other embodiments or features or examples described herein, this disclosure should be read to describe any such combinations that would be practicable by one of ordinary skill in the art. Indeed, the above detailed description of embodiments of the present technology are not intended to be exhaustive or to limit the present technology to the precise form disclosed above. Although specific embodiments of, and examples for, the present technology are described above for illustrative purposes, various equivalent modifications are possible within the scope of the present technology as those skilled in the relevant art will recognize. For example, although steps are presented in a given order, alternative embodiments can perform steps in a different order. The various embodiments described herein can also be combined to provide further embodiments.

Furthermore, the described features, structures, characteristics or examples of the present technology may be combined in any suitable manner in one or more examples. In the preceding description, numerous specific details were provided, such as examples of various configurations to provide a thorough understanding of examples of the described technology. It will be recognized, however, that the present technology may be practiced without one or more of the specific details, or with other methods, components, devices, etc. In other instances, well-known structures or operations are not shown or described in detail to avoid obscuring aspects of the technology.

Moreover, unless the word “or” is expressly limited to mean only a single item exclusive from other items in reference to a list of two or more items, then the use of “or” in such a list is to be interpreted as including (a) any single item in the list, (b) all of the items in the list, or (c) any combination of the items in the list. In other words, the use of “or” in this disclosure should be understood to mean non-exclusive “or” (i.e., “and/or”) unless otherwise indicated herein.

Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications can be made without deviating from the technology. Further, while advantages associated with some embodiments of the present technology have been described in the context of those embodiments, other embodiments can also exhibit such advantages, and not all embodiments need necessarily exhibit such advantages to fall within the scope of the technology. Accordingly, the disclosure and associated present technology can encompass other embodiments not expressly shown or described herein.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described present technology.

What is claimed is:

1. A drawworks brake performance assessment system operable within a drill rig for determining, in real-time, braking performance of a braking system of a drawworks during a drilling operation, the system comprising:
a drawworks comprising:
a rotatable spool having a drum operable to receive a drilling line; and
a braking system comprising at least one rotor and at least one hydraulic disc brake, the at least one rotor being associated with the rotatable spool such that the at least one rotor rotates with the rotation of the rotatable spool, the at least one hydraulic disc brake comprising:
a master cylinder assembly;
a caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor; and
a brake sensor system comprising a sensor and an operations module, the sensor being operable with the hydraulic disc brake of the braking system of the drawworks to measure a displacement distance between at least one of the opposing brake pads and a surface of the rotor, and to output corresponding sensor data to the operations module,
wherein the operations module comprises a computing device operable to receive and process the sensor data and to determine one or more performance characteristics of the braking system based on the sensor data.

2. The drawworks brake performance assessment system of claim 1, wherein the braking system of the drawworks comprises a plurality of hydraulic disc brakes, including the at least one hydraulic disc brake, each of the plurality of hydraulic disc brakes being operable with and positioned at different positions on the rotor, and wherein the brake sensor system comprises two or more sensors, each operable with a respective hydraulic disk brake of the plurality of hydraulic disc brakes, and each operable to measure a displacement distance between at least one of the opposing brake pads of the respective hydraulic disc brake and the rotor, and to output corresponding sensor data to the operations module.

3. The drawworks brake performance assessment system of claim 2, wherein the one or more performance characteristics of the braking system comprises a first performance characteristic based on sensor data from one of the two or more sensors, and a second performance characteristic based on sensor data from the other of the two or more sensors.

4. The drawworks brake performance assessment system of claim 3, wherein the first and second performance characteristics are comparable to determine a comparison performance characteristic.

5. The drawworks brake performance assessment system of claim 1, wherein the one or more performance characteristics of the braking system comprises a unit of measurement representative of a directly measured aspect of the braking system.

6. The drawworks brake performance assessment system of claim 1, wherein the one or more performance characteristics of the braking system is determined by the computing device, and is based on the sensor data from a single sensor operating on a single hydraulic disc brake.

7. The drawworks brake performance assessment system of claim 1, wherein the brake sensor system further comprises a notification system operable to provide feedback to a rig operator based on the one or more performance characteristics of the braking system, the notification system comprising at least one notification device.

8. The drawworks brake performance assessment system of claim 7, wherein the notification device comprises at least one of an audible device configured to provide audible feedback, a visual device configured to provide visible feedback, or a haptic device configured to provide haptic feedback.

9. The drawworks brake performance assessment system of claim 7, wherein the computing device of the operations module is operable to compare a current given performance characteristic of the one or more performance characteristics of the braking system to a stored pre-determined threshold associated with the given performance characteristic, and to provide feedback to the rig operator in the form of a warning based on the current given performance characteristic breaching the threshold.

10. The drawworks brake performance assessment system of claim 1, wherein the sensor comprises a linear position sensor.

11. The drawworks brake performance assessment system of claim 1, wherein the sensor comprises a Linear Variable Differential Transformer (LVDT).

12. The drawworks brake performance assessment system of claim 1, wherein the operations module is integrated with and part of a high-level control system.

13. The drawworks brake performance assessment system of claim 1, wherein the rotor comprises a flange of the rotatable spool.

14. The drawworks brake performance assessment system of claim 1, wherein the brake sensor system further comprises a high-level control system interface.

15. The drawworks brake performance assessment system of claim 14, further comprising a high-level control system operable to control operation of the drawworks and the braking system of the drawworks, the high-level control system comprising a brake sensor system interface in communication with the high-level control system interface to facilitate transfer of data between one or more components of the brake sensor system and the high-level control system.

16. The drawworks brake performance assessment system of claim 1, further comprising a braking system interface operable to support the sensor on the hydraulic disc brake in a proper sensing position.

17. The drawworks brake performance assessment system of claim 16, wherein the braking system interface comprises a bracket assembly.

18. The drawworks brake performance assessment system of claim 17, wherein the bracket assembly comprises a first bracket mounted to a fixed reference point of the hydraulic disc brake and a fixed portion of the sensor, and a second bracket mounted to a moveable reference point of the hydraulic disc brake and to a moveable portion of the sensor.

19. A drawworks operable within a drilling rig, the drawworks comprising:
a rotatable spool having a drum; and
a braking system comprising:
a rotor associated with the rotatable spool such that the at least one rotor rotates with the rotation of the rotatable spool;
a first hydraulic disc brake comprising a master cylinder assembly, and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor;
a second hydraulic disc brake comprising a master cylinder assembly, and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor; and
a brake sensor system operable with the braking system, and comprising first and second sensors and an operations module,
wherein the first sensor is operable with the first hydraulic disc brake of the braking system to measure a displacement distance of one of the opposing brake pads and the rotor, and to output corresponding sensor data,
wherein the second sensor is operable with the second hydraulic disc brake of the braking system to measure a displacement distance of one of the opposing brake pads and the rotor, and to output corresponding sensor data
wherein the operations module comprises a computing device operable to receive the sensor data from the first and second sensors and to determine one or more performance characteristics of the braking system based on the sensor data.

20. The drawworks of claim 19, wherein the first and second hydraulic disc brakes are operable with and positioned at different positions on the rotor.

21. The drawworks of claim 20, wherein the one or more performance characteristics of the braking system comprises a first performance characteristic based on sensor data from the first sensor, and a second performance characteristic based on sensor data from the second sensor.

22. The drawworks of claim 20, wherein the first and second performance characteristics are comparable to determine a comparison performance characteristic.

23. The drawworks of claim 19, wherein the one or more performance characteristics of the braking system comprises a unit of measurement representative of a directly measured aspect of the braking system.

24. The drawworks of claim 19, wherein the one or more performance characteristics of the braking system is determined by the computing device, and based on the sensor data from a single sensor operating on a single hydraulic disc brake.

25. The drawworks of claim 19, wherein the brake sensor system further comprises a notification system operable to provide feedback to a rig operator based on the performance characteristics of the braking system.

26. The drawworks of claim 25, wherein the notification system comprises at least one of an audible system configured to provide audible feedback, a visual system configured to provide visible feedback, or a haptic system configured to provide haptic feedback.

27. The drawworks of claim 25, wherein the computing device of the operations module is operable to compare a current given performance characteristic of the one or more performance characteristics of the braking system to a stored pre-determined threshold associated with the given performance characteristic, and to provide the feedback to the rig operator based on the current given performance characteristic breaching the threshold.

28. The drawworks of claim 19, wherein the sensor comprises a linear position sensor.

29. The drawworks of claim 19, wherein the sensor comprises a Linear Variable Differential Transformer (LVDT).

30. The drawworks of claim 19, wherein the operations module is integrated with and part of a high-level control system.

31. The drawworks of claim 19, wherein the at least one disc is integrally formed with the drum.

32. The drawworks of claim 19, wherein the brake sensor system further comprises a high-level control system interface.

33. The drawworks of claim 32, further comprising a high-level control system operable to control operation of the drawworks and the braking system of the drawworks, the high-level control system comprising a brake sensor system interface in communication with the high-level control system interface to facilitate transfer data between one or more components of the brake sensor system and the high-level control system.

34. A brake sensor system operable with a drawworks of a drilling rig, the brake sensor system comprising:
a plurality of sensors, each operable with a respective hydraulic disc brake of a braking system of a drawworks of a drilling rig, wherein each respective hydraulic disc brake comprises a master cylinder assembly, and a caliper assembly, the caliper assembly comprising a caliper and opposing brake pads supported by the caliper and operable to engage a rotor, wherein the master cylinder assembly is operable with the caliper assembly to manipulate at least one of the opposing brake pads to apply a clamping force to the rotor;
a plurality of braking system interfaces, each comprising a mounting assembly operable to support a sensor of the plurality of sensors on a respective hydraulic disc brake in a position suitable for measuring a displacement distance between at least one of the opposing brake pads and the rotor, and to output corresponding sensor data; and
an operations module comprising at least one processor, and one or more memory devices including instructions that, when executed by the at least one processor, cause the system to:
selectively operate the plurality of sensors, each sensor configured to measure a displacement distance between the rotor and at least one of the opposing brake pads of a hydraulic disc brake of the plurality of hydraulic disc brakes;
receive the sensor data from one or more sensors of the plurality of sensors;
determine one or more performance characteristics of the braking system of the drawworks based on the sensor data; and
communicate the one or more performance characteristics to an operator.

35. The system of claim 34, further comprising a notification system comprising at least one notification device, the notification system being operable with the operations module to communicate the one or more performance characteristics to an operator.

36. The system of claim 35, wherein the one or more memory devices further includes instructions that, when executed by the at least one processor, cause the system to:
access a stored, pre-determined threshold value associated with a given performance characteristic of the one or more performance characteristics of the braking system;
compare a current value of the given performance characteristic to the stored, pre-determined threshold value; and
provide feedback to the operator in the form of a warning based on the current value of the given performance characteristic breaching the threshold value.

37. The system of claim 34, wherein the one or more performance characteristics comprises a clamping force of the respective hydraulic disc brake.

38. The system of claim 34, wherein the operations module comprises a dedicated computer.

39. The system of claim 34, wherein the operations module is configured to be integrally formed with a high-level control system of at least one of the drawworks or a drilling rig in which the drawworks operates.

40. The system of claim 34, wherein the sensor comprises a Linear Variable Differential Transformer (LVDT).

41. The system of claim 34, wherein the one or more performance characteristics comprises one that is calculated and obtained indirectly from the sensor data.

42. The system of claim 34, wherein the one or more performance characteristics comprises a comparison performance characteristic obtained indirectly from the sensor data from at least two sensors and at least two corresponding hydraulic disc brakes operable within the braking system of the drawworks.

43. The system of claim 34, wherein the plurality of sensors are each supported on a different respective hydraulic disc brake operable with the rotor, and wherein the one or more performance characteristics is based on a relative comparison of sensor data from at least two of the plurality of sensors.

44. The system of claim 34, wherein the one or more memory devices further includes instructions that, when executed by the at least one processor, cause the system to:
receive sensor data from two or more sensors of the plurality of sensors associated with respective two or more hydraulic disc brakes operating within the braking system; and
determine a plurality of performance characteristics of the braking system based on the sensor data from the two or more sensors.

45. The system of claim 34, wherein the operations module is integrated with and part of a high-level control system.

46. The system of claim 34, wherein the plurality of braking system interfaces each comprise a mounting assembly operable to mount, at least in part, to a caliper of a respective hydraulic disc brake, wherein the mounting assembly is configured to support a sensor of the plurality of sensors.

47. A method for facilitating the determination, in real-time, of one or more performance characteristics of a braking system of a drawworks of a drilling rig during a drilling operation, the method comprising:
configuring a drawworks with a rotatable spool having a drum;
configuring the drawworks with a braking system operable with the rotatable spool, the braking system comprising at least one rotor operable with at least one hydraulic disc brake comprising a master cylinder assembly and a caliper assembly, the caliper assembly comprising a caliper and opposing brake pads supported by the caliper and operable to engage the rotor, wherein the master cylinder assembly is operable with the caliper assembly to manipulate at least one of the opposing brake pads to apply a clamping force to the rotor;
configuring the drawworks to comprise a brake sensor system operable to measure a displacement distance between at least one of the opposing brake pads and the one or more rotors, and to output corresponding sensor data to an operations module; and
facilitating the determination of one or more performance characteristics of the braking system based on the sensor data.

48. The method of claim 47, further comprising:
configuring the braking system to comprise a plurality of hydraulic disc brakes, each being operable with and positioned at different positions on the rotor; and
configuring the brake sensor system to comprise two or more sensors, each operable with a respective hydraulic disc brake of the plurality of hydraulic disc brakes, and each operable to measure a displacement distance between at least one of the opposing brake pads of the respective hydraulic disc brakes and the at least one rotor, and to output corresponding sensor data to the operations module.

49. The method of claim 47, further comprising facilitating the determination of a first performance characteristic based on sensor data from one of the two or more sensors, and a second performance characteristic based on sensor data from the other of the two or more sensors.

50. The method of claim 49, further comprising facilitating the comparison of the first and second performance characteristics to determine a comparison performance characteristic.

51. The method of claim 47, further comprising configuring the brake sensor system to comprise a notification system operable to provide feedback to a rig operator based on at least one of the sensor data or the one or more performance characteristics.

52. The method of claim 47, further comprising facilitating comparison of a current given performance characteristic of the one or more performance characteristics to a stored, pre-determined threshold corresponding to the given performance characteristic, and providing the feedback to the rig operator in the form of a warning indicative of the current given performance characteristic breaching the threshold.

53. The method of claim 47, further comprising configuring the caliper assembly to further comprise a caliper piston supported by the caliper, the caliper piston being operable to manipulate at least one of the opposing brake pads to apply a clamping force to the at least one rotor.

54. The method of claim 47, further comprising configuring the brake sensor system to comprise a sensor in the form of a linear position sensor.

55. The method of claim 47, further comprising configuring the brake sensor system to comprise a sensor in the form of a Linear Variable Differential Transformer (LVDT).

56. The method of claim 47, further comprising configuring the operations module of the brake sensor system to be integrated with a high-level control system interface.

57. The method of claim 47, further comprising configuring the brake sensor system to comprise a drawworks braking system interface operable to support one or more sensors from the at least one hydraulic disc brake.

58. The method of claim 47, wherein the braking system and the brake sensor system form a drawworks brake performance assessment system.
